(19) United States
(12) Patent Application Publication
(10) Pub. No.: US 2017/0248742 A1
(43) Pub. Date: Aug. 31, 2017

(54) LIGHT REDIRECTING FILM CONSTRUCTIONS AND METHODS OF MAKING THEM

(71) Applicant: 3M INNOVATIVE PROPERTIES COMPANY, SAINT PAUL, MN (US)

(72) Inventors: MANOJ NIRMAL, SAINT PAUL, MN (US); JOHN P. BAETZOLD, NORTH SAINT PAUL, MN (US); ERIK A. AHO, NEW RICHMOND, WI (US); SUMAN K. PATEL, WOODBURY, MN (US); SCOTT M. TAPIO, FALCON HEIGHTS, MN (US); MIKHAIL L. PEKUROVSKY, BLOOMINGTON, MN (US); JOHN J. STRADINGER, ROSEVILLE, MN (US); BING HAO, WOODBURY, MN (US)

(73) Assignee: 3M INNOVATIVE PROPERTIES COMPANY, SAINT PAUL, MN (US)

(21) Appl. No.: 15/519,904

(22) PCT Filed: Oct. 16, 2015
(86) PCT No.: PCT/US15/55908

§ 371 Date: Apr. 18, 2017

Related U.S. Application Data
(60) Provisional application No. 62/065,932, filed on Oct. 20, 2014.

(51) Int. Cl. G02B 5/02; F21S 11/00

(52) U.S. Cl. CPC G02B 5/0231; F21S 11/007; G02B 5/0278

(57) ABSTRACT

The present disclosure relates to articles and methods of making light redirecting film constructions comprising a microstructured optical film bonded in selected areas to another film. This type of assembly may serve various purposes. For example, the assembly may protect the structured film, provide additional functionality, such as diffusion, and/or facilitate attachment of the microstructured optical film to a mounting surface, such as a window.

The present disclosure relates to articles and methods of making light redirecting film constructions comprising a microstructured optical film, such as a daylight redirecting film, bonded in selected areas to another film. This type of assembly may serve various purposes. For example, the assembly may protect the structured film, provide additional functionality, such as diffusion, and/or facilitate attachment of the microstructured optical film to a mounting surface, such as a glazing or window pane.

### BACKGROUND

A variety of approaches are used to reduce energy consumption in buildings. Among those approaches is the more efficient use of sunlight to provide lighting inside buildings. One technique for supplying light inside of buildings, such as in offices, residential buildings, etc. is the redirection of incoming sunlight. Because sunlight enters windows at a downward angle, much of this light is not useful in illuminating a room. However, if the incoming downward light rays can be redirected upward such that they strike the ceiling, the light can be more usefully employed in lighting the room.

Light Redirection Films (LRFs), provide natural lighting by redirecting incoming sunlight upward, onto the ceiling. This can lead to significant energy savings by reducing the need for artificial lights. Light Redirection Films can consist of linear optical microstructures that reflect incoming sunlight onto the ceiling. LRFs are typically installed on the upper clerestory section of windows 7′ and above. A typical configuration is shown on FIG. 1, where an LRF 101 on a window 110 redirects sunlight 120 upward as deflected light 124.

Sunlight that would normally land on the floor can be used to provide natural lighting by using suitable constructions involving daylight redirecting films. FIG. 2 shows an example of the amount of light that can be redirected from the floor to the ceiling by the use of a LRF 201.

Buildings (residential & commercial) account for about 40% of all energy consumed and lighting represents about 30% of that energy. Substituting even a fraction of artificial lighting with natural light can yield significant energy savings. The Illuminating Engineering Society of North America (IES) has developed a comprehensive daylight illuminance metric, named spatial Daylight Autonomy or sDA that characterizes the efficacy of daylighting systems. An extensive study conducted at several Department of Defense sites across the U.S. demonstrated that installation of 3M daylight redirecting film increases sDA values. In addition to energy savings, daylighting has soft benefits related to increased worker productivity, elevated test scores, and improved mood and energy.

A problem that is frequently encountered when an area is illuminated using natural daylight is how to spread the light adequately and evenly. In the case, for example, in which an area is being illuminated within a building, there will usually be parts of that area that are less well lit than others, and also some locations where the users of the building are troubled by glare from the light source. One solution to address this problem is the use of a diffuser.

In general, microstructured light redirecting films may be fragile under certain circumstances because the microstructured features may be subject to mechanical damage and/or chemical damage (e.g. window cleaners). One challenge when attempting to protect the microstructured elements in a LRF is that the lamination process to add a cover or protective layer can cause damage to those microstructured elements. The same challenge is present when attempting to laminate any other type of functional layer or film, such as a diffuser, to a LRF on the side of the microstructured elements. Additionally, the presence of an additional layer next to the LRF may also modify its optical properties and significantly decrease or nullify its light redirecting properties. One of the goals of the present disclosure is to provide for film constructions that allow the bonding of a microstructured film, such as a LRF, to another functional film, without significantly sacrificing the optical performance of the microstructured film.

### SUMMARY

The present disclosure is directed to articles and methods of making light redirecting film constructions comprising a microstructured optical film in the form of a light redirecting layer bonded in selected areas to another film.

Some embodiments of the articles of the present disclosure include one or more optically active areas within the microstructured optical film, as well as one or more partially optically active areas. Those areas may be partially active depending on whether the adhesive flows all the way to the bottom of the microstructure. In such a case, light redirection may still occur, but to a lesser degree. In the case of a light redirecting layer, the optically active areas allow the redirection of incident light. When incident light hits the one or more partially optically active areas, the light is not substantially redirected by the microstructured prismatic elements in the light redirecting layer. The one or more optically active areas include a material adjacent to the microstructured prismatic elements, such as air or any other synthetic alternatives, like aerogel, that have a refractive index that allows the microstructured prismatic elements to redirect light. The one or more partially optically active areas include a material, typically an adhesive (e.g., a pressure sensitive adhesive or any other suitable adhesive) adjacent to a portion of the microstructured prismatic elements. The presence of the adhesive degrades the ability to redirect light for the portions of the daylight redirecting layer that are directly adjacent thereto. The barrier elements of this disclosure, which typically have a refractive index similar to that of the refractive index of the LRF, assist in maintaining the redirecting properties of the microstructured prismatic elements by forming a “barrier” between the microstructured prismatic elements and the adhesive. The barrier elements allow the presence of a low index interface for the LRF structures (e.g., air or aerogel if desired) The refractive index difference between air and the LRF allows redirection of the incident light.

The barrier elements of the present disclosure have sufficient structural integrity to substantially prevent flow of the adhesive into the microstructured prismatic elements, which would displace the air. The barrier elements may be made from any suitably curable polymeric material. Exemplary materials for inclusion in the barrier elements include multi-functional or cross-linkable monomer, resins, polymeric materials, inks, dyes, and vinyls. Illustrative cross-linkable monomers include multi-functional acrylates, urethanes, urethane acrylates, siloxanes, and epoxies. In some embodiments, cross-linkable monomers include mixtures of multifunctional acrylates, urethane acrylates, or epoxies. In some embodiments, the barrier elements comprise a plurality of inorganic nanoparticles. The inorganic nanoparticles can include, for example, silica, alumina, or Zirconia nanoparticles. In some embodiments, the nanoparticles have a mean diameter in a range from 1 to 200 microns, or 5 to 150 microns, or 5 to 125 microns. In illustrative embodiments, the nanoparticles can be “surface modified” such that the nanoparticles provide a stable dispersion in which the nanoparticles do not agglomerate after standing for a period of time, such as 24 hours, under ambient conditions.

In some embodiments, the barrier element traps a low refractive index material (such as air or aerogel) in the area adjacent the microstructured prismatic elements.

In one embodiment, the present disclosure is directed to an article comprising: a) a light redirecting layer comprising a first major surface and a second major surface; b) one or more barrier elements; and c) an adhesive layer; subject to the following conditions (see also FIGS. 11 to 13):
the light redirecting layer comprises one or more microstructured prismatic elements on its first major surface defining a light redirecting area;
the total surface area of the one or more barrier elements is greater than 60% of the light redirecting area;
the adhesive layer comprises a first major surface and a second major surface;
the first major surface of the adhesive layer has a first region and a second region;
the first region of the first surface of the adhesive layer is in contact with one or more barrier elements;
the second region of the first surface of the adhesive layer is in contact with one or more microstructured prismatic elements; and
the article allows transmission of visible light.

In other embodiments, the present disclosure is directed to films that comprise an article as described above. In yet other embodiments, the present disclosure is directed to windows comprising films or articles as described herein.

In another embodiment, the present disclosure is directed to methods of making an article comprising: a) providing a first substrate having a first major surface and a second major surface opposite the first major surface; b) applying an adhesive layer to the first major surface of the first substrate (wherein the adhesive layer has a first major surface and a second major surface opposite the first major surface; and wherein the second major surface of the adhesive layer is immediately adjacent the first major surface of the first substrate); c) printing one or more barrier elements on the first major surface of the adhesive layer; d) setting the one or more barrier elements; and d) laminating a light redirecting layer on the first major surface of the adhesive layer; subject to the following conditions:
the light redirecting layer comprises one or more microstructured prismatic elements on its first major surface defining a light redirecting area;
the total surface area of the one or more barrier elements is greater than 60% of the light redirecting area;
the first major surface of the adhesive layer has a first region and a second region;
the first region of the first surface of the adhesive layer is in contact with the one or more barrier elements;
the second region of the first surface of the adhesive layer is in contact with one or more microstructured prismatic elements; and
the article allows transmission of visible light.

Films and windows comprising the constructions disclosed in this application are also within the scope of the present disclosure.

All scientific and technical terms used herein have meanings commonly used in the art unless otherwise specified. The definitions provided herein are to facilitate understanding of certain terms used frequently in this application and are not meant to exclude a reasonable interpretation of those terms in the context of the present disclosure.

Unless otherwise indicated, all numbers in the description and the claims expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviations found in their respective testing measurements.

The recitation of numerical ranges by endpoints includes all numbers subsumed within that range (e.g. a range from 1 to 5 includes, for instance, 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

The term “adhesive” as used herein refers to polymeric compositions useful to adhere together two components (adherents).

The term “window film adhesive layer” as used herein refers to a layer comprising an adhesive suitable to bond a film to a window or glazing, such as, for example, a pressure sensitive adhesive.

The term “adjacent” as used herein refers to the relative position of two elements, such as layers in a film construction, that are close to each other and may or may not be necessarily in contact with each other and may have one or more layers separating the two elements, as understood by the context in which “adjacent” appears.

The term “immediately adjacent” as used herein refers to the relative position of two elements, such as layers in a film construction, that are immediately next to each other without having any other layers separating the two elements, as understood by the context in which “immediately adjacent” appears.

The term “construction” or “assembly” are used interchangeably in this application when referring to a multilayer film, in which the different layers can be coextruded, laminated, coated one over another, or any combination thereof.

The term “light redirecting layer” as used herein refers to a layer that comprises micro structured prismatic elements.

The term “light redirecting film” as used herein refers to a film that comprises one or more light redirecting layers and optionally other additional layers, such as substrates or other functional layers.

Light redirection, in general, may be called daylight redirection, sunlight redirection, or solar light redirection when the source of light is the sun.

The term “film” as used herein refers, depending on the context, to either a single layer article or to a multilayer construction, where the different layers may have been laminated, extruded, coated, or any combination thereof.

The term “barrier elements” as used herein refers to physical features laid on top of regions of an adhesive layer that help maintain the optical performance of the light redirecting layer when the adhesive layer and light redirecting layer are bonded to each other in opposing fashion. The barrier elements prevent the adhesive layer from filling the space surrounding microstructured prismatic elements and are able to provide an interface between the LRF and a low refractive index material, such as air or aerogel. In certain instances in this disclosure the barrier elements are also called “passivation islands,” or “islands.”

The term “microstructured prismatic element” as used herein refers to an engineered optical element, wherein at least 2 dimensions of the features are microscopic, that redirects input light with certain angular characteristics into output light with certain angular characteristics. In certain embodiments, the height of the microstructured prismatic element is less than 1000 microns. A microstructured prismatic element may comprise a single peak structure, a multipeak structure, such as a double peak structure, structures comprising one or more curves, or combinations thereof. The microstructured prismatic elements, including all of their physical and optical characteristics (e.g., glare, TIR angles, etc.), disclosed in provisional applications titled “Room-Facing Light Redirecting Film with Reduced Glare” and “Sun-Facing Light Redirecting Film with Reduced Glare,” both filed on Oct. 20, 2014, are hereby incorporated by reference.

The term “diffusing agent” as used herein refers to features or additives incorporated in the article that increase the angular spread of light passing through the same article.

The term “repeating 1-dimensional pattern” as used herein refers to features that are periodic along one direction in reference to the article.

The term “repeating 2-dimensional pattern” as used herein refers to features that are periodic along 2 different directions in reference to the article.

The term “random-looking 1- or 2-dimensional pattern” as used herein refers to features that appear not to be periodic or semi-periodic along one or two different directions in reference to the article. Those features may still be periodic but with a period sufficiently larger than the mean pitch of individual features so that the period is not noticeable to most viewers.

As used herein, the index of refraction of a material 1 (“RI1”) is said to “match” the index of refraction of a material 2 (“RI2”) if the value RI1 is within +/−5% of RI2.

For the following definitions of “room-facing” and “sun-facing,” it is assumed that a light redirecting layer has a first major surface and second major surface opposite the first major surface and that the first major surface of the light redirecting film comprises microstructured prismatic elements.

As used herein, the term “room-facing,” in the context of a light redirecting film or a construction comprising a light redirecting film, refers to a film or construction where the incident light rays pass through the major surface of the light redirecting film not containing the microstructured prismatic elements before they pass through the mojor surface that contains the microstructured prismatic elements. In the most typical configuration, when the light redirecting film is located on an exterior window (i.e., when the window faces the exterior of a building), the microstructured prismatic elements in a “room-facing” configuration are oriented facing the interior of the room. However, the term “room-facing,” as defined herein can also refer to configurations where the light redirecting film is on a glazing, or other kind of substrate, that does not face the exterior of the building, but is in between two interior areas.

As used herein, the term “sun-facing,” in the context of a light redirecting film or a construction comprising a light redirecting film, refers to a film or construction where the incident light rays pass through the major surface of the light redirecting film containing the microstructured prismatic elements before they pass through the other major surface (the major surface not containing the microstructured prismatic elements). In the most typical configuration, when the light redirecting film is located on an exterior window (i.e., when the window faces the exterior of a building), the microstructured prismatic elements in a “sun-facing” configuration are oriented facing the sun. However, the term “sun-facing,” as defined herein can also refer to configurations where the light redirecting film is on a glazing that does not face the exterior of the building, but is in between two interior areas.

As used herein, the term “sealing” or “sealed” when referring to an edge of an article of this disclosure means blocking the ingress of certain undesired elements such as moisture or other contaminants.

The term “setting” as used herein refers to transforming a material from an initial state to its final desired state with different properties such as flow, stiffness, etc., using physical (e.g. temperature, either heating or cooling), chemical, or radiation (e.g. UV or e-beam radiation) means.

The term “visible light” as used herein refers to refers to radiation in the visible spectrum, which in this disclosure is taken to be from 400 nm to 700 nm.

### BRIEF DESCRIPTION OF THE DRAWINGS

FIG. 1 is a typical configuration showing the use of a light redirecting film, demonstrating light redirection after the light passed through a room-facing light redirecting layer.

FIG. 2 shows an example of the amount of light that can be redirected from the floor to the ceiling by the use of a LRF (see the arrow showing the portion of the light redirected from the floor to the ceiling).

FIG. 3 shows a visual example of a solar column (white bar) on a window.

FIG. 4 shows the effect of a diffuser layer on a light redirecting film.

FIG. 5 shows a configuration using a two-film solution for combining a diffuser layer with a light redirecting film.

FIG. 6 shows an example in which barrier elements (or “islands”) have been printed on an adhesive.

FIG. 7 is a schematic diagram of a typical process to bond a microstructured film to a second film.

FIG. 8 shows the phenomenon of “punch through” and one option to minimize it by using an opaque adhesive in those areas.

FIG. 9 shows three different patterns for barrier elements.

FIG. 10 shows punch through glare for single-film light redirecting film/diffuser constructions.

FIG. 11 shows a construction having both clear view-through regions and light redirecting regions.

FIG. 12 shows a room-facing configuration having a light redirecting film and diffuser.

FIG. 13 shows two different sun-facing configurations having a light redirecting film and diffuser. The panel on the left-hand side is FIG. 13(a) and the panel on the right-hand side is FIG. 13(b).

FIG. 14 shows an embodiment comprising see-through regions and light redirecting regions.

FIG. 15 shows an example of random-looking two-dimensional barrier elements on an adhesive layer.

FIG. 16 shows an embodiment of a laminate comprising a light redirecting film laminated to a film comprising barrier elements.

FIG. 17 is a cross-sectional view of a laminate, showing that adhesive may flow and fill the air gaps in the microstructures.

### ELEMENT NUMBERS

101 Light redirection film
110 Window glazing
120 Sunlight
122 Sunlight not passing through light redirection film
124 Sunlight deflected upward by light redirection film
201 Light redirection film applied to window glazing
501a Light redirection film
505a Diffuser
510a Window glazing
512a Window glazing
514a Window glazing
530a Insulated glazing unit
501b Light redirecting construction
510b Window glazing
512b Window glazing
530b Insulated glazing unit
640 Barrier element
645 Adhesive
700 Article
740 Barrier element
743 Adhesive film layer
745 Adhesive layer
747 Liner
750 Light redirecting layer
751 Film
752 First major surface of light redirecting layer
754 Second major surface of light redirecting layer
756 Microstructured prismatic element
760 Air
846 Opaque adhesive
865 Punch through (blocked by opaque adhesive)
1070 Punch through
1100 Construction
1140 Barrier element
1145 Adhesive
1146 First major surface of adhesive
1147 Second major surface of adhesive
1148 First region
1149 Second region
1150 Light redirecting layer
1152 First major surface of light redirecting layer
1154 Second major surface of light redirecting layer
1156 Microstructured prismatic element
1165 Light ray
1173 Light ray
1175 Light ray passing through region 1149 with little scattering
1200 Room-facing light redirecting assembly
1210 Window glazing
1240 Barrier elements
1243 Cover film
1245 Adhesive
1247 Window film adhesive
1250 Daylight redirecting film
1251 Substrate
1256 Light redirecting microstructure
1265 Incoming sunlight ray
1266 Deflected light ray
1280 Diffuser
1300a Assembly
1300b Assembly
1310a Window glazing
1310b Window glazing
1335a Adhesive
1340a Barrier element
1340b Barrier element
1343a Cover film
1343b Cover film
1345 Adhesive
1347a Window film adhesive
1350a Light redirecting layer
1350b Light redirecting layer
1351a Substrate
1351b Substrate
1356a Light redirecting microstructures
1356b Light redirecting microstructures
1365a Incoming sunlight ray
1365b Incoming sunlight ray
1366a Redirected light ray
1366b Redirected light ray
1380a Diffuser
1380b Diffuser
1385 Substrate
1400 Light redirecting construction
1475 See-through region
1478 Light redirecting region
1795 Region where adhesive has flowed to bottom of microstructure

In the following description, reference is made to the accompanying drawings herein described. In certain cases, the Figures may depict, by way of illustration, several specific embodiments of the present disclosure. It is to be understood that other embodiments different from those explicitly depicted in the Figures are contemplated and may be made without departing from the scope or spirit of the present disclosure. The following detailed description, therefore, is not to be taken in a limiting sense.

### DETAILED DESCRIPTION

In general, the present disclosure relates to articles and methods of making film constructions where two films are bonded to each other and at least one of the films comprises a microstructured optical film. In a typical example, the microstructured optical film may be a light redirecting film. The disclosure in the application is exemplified by referring to light redirecting films and light redirecting layers as being part of the overall construction, but the concepts and subject matter taught and claimed in this application can extend to other microstructured optical films that are not light redirecting films.

The type of bonding disclosed and taught in this application between two films refers to bonding only via selected areas in the light redirecting film in order to preserve the light redirecting function (or a suitable function in other microstructured optical films) of the film. Because the presence of the adhesive contacting the microstructured prismatic elements substantially destroys the ability to redirect light, there is a natural balance between the size of the areas that effect the bonding (partially optically active areas) between the two films and the size of the areas that are optically active (able to redirect light). That is, as the size of the bonding area between the two films increases, the strength of the bond increases, which is beneficial, but there is also less area left to perform the light redirecting function of the original light redirecting film. Conversely, as the size of the light redirecting area increases, the higher amount of light is redirected, but the size of the area available for bonding decreases as does the strength of the bond between the two films.

The inventors of the present application have surprisingly created articles where the optically area is greater than 90% of the total available area but that still have suitable bond strength to maintain both films bonded for certain applications, including preparation of window films for commercial, residential, and even automotive applications.

The type of construction proposed in this application may serve various purposes. For example, the assembly may protect the light redirecting film, the second film to which the light redirecting film is bonded may provide additional functionality, such as diffusion, and the construction may also facilitate attachment of the light redirecting film to a mounting surface, such as a window.

Bonding the two films offers other significant advantages. For example, the resulting construction can have improved handling, rigidity, and provide the ability to attain thinner final constructions.

Basic Constructions

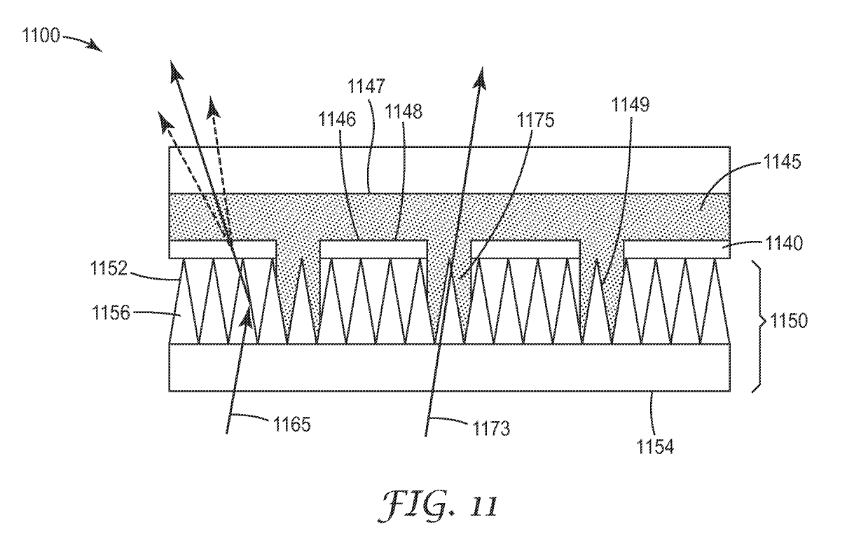

In one embodiment, the present disclosure is directed to an article comprising: a) a light redirecting layer comprising a first major surface and a second major surface; b) one or more barrier elements; and c) an adhesive layer; subject to the following conditions (see also FIGS. 11 to 13):
the light redirecting layer comprises one or more microstructured prismatic elements on its first major surface defining a light redirecting area;
the total surface area of the one or more barrier elements is greater than 60% of the light redirecting area;
the adhesive layer comprises a first major surface and a second major surface;
the first major surface of the adhesive layer has a first region and a second region;
the first region of the first surface of the adhesive layer is in contact with one or more barrier elements;
the second region of the first surface of the adhesive layer is in contact with one or more microstructured prismatic elements; and
the article allows transmission of visible light.

In certain embodiments, the light redirecting layer comprises a light redirecting substrate, and the one or more microstructured prismatic elements are on the light redirecting substrate.

In other embodiments, to provide support to the microstructured prismatic elements, the constructions of this disclosure further comprise a first substrate adjacent the second major surface of the adhesive layer.

Diffusive Layers Coupled to Light Redirecting Films

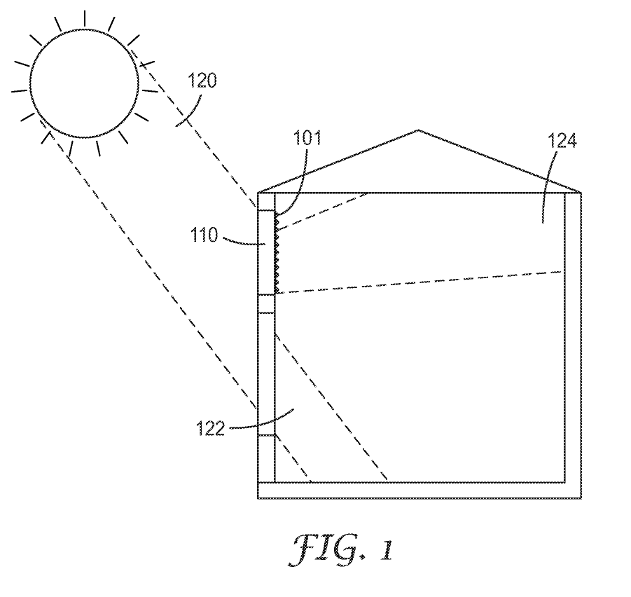

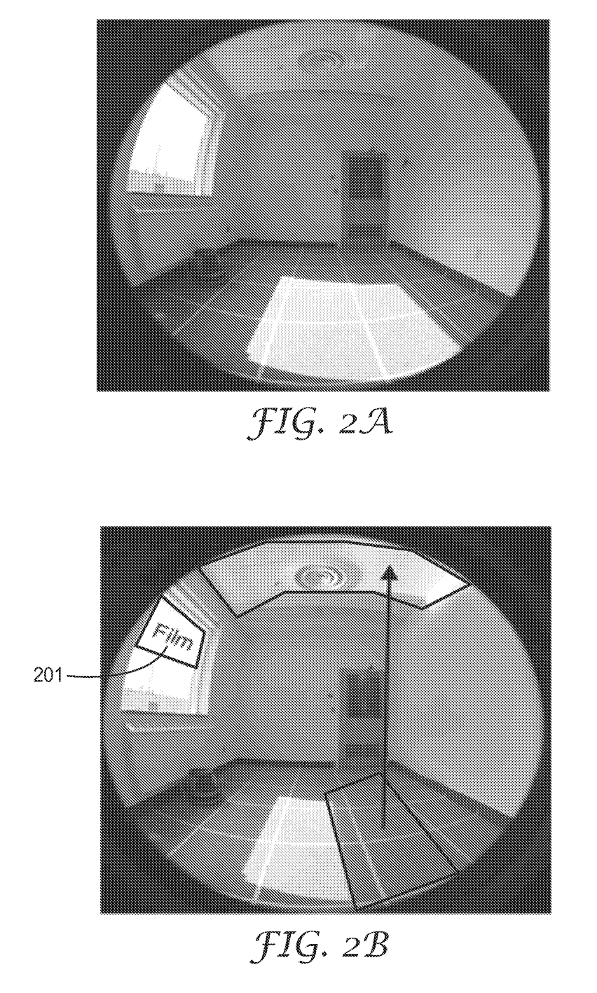

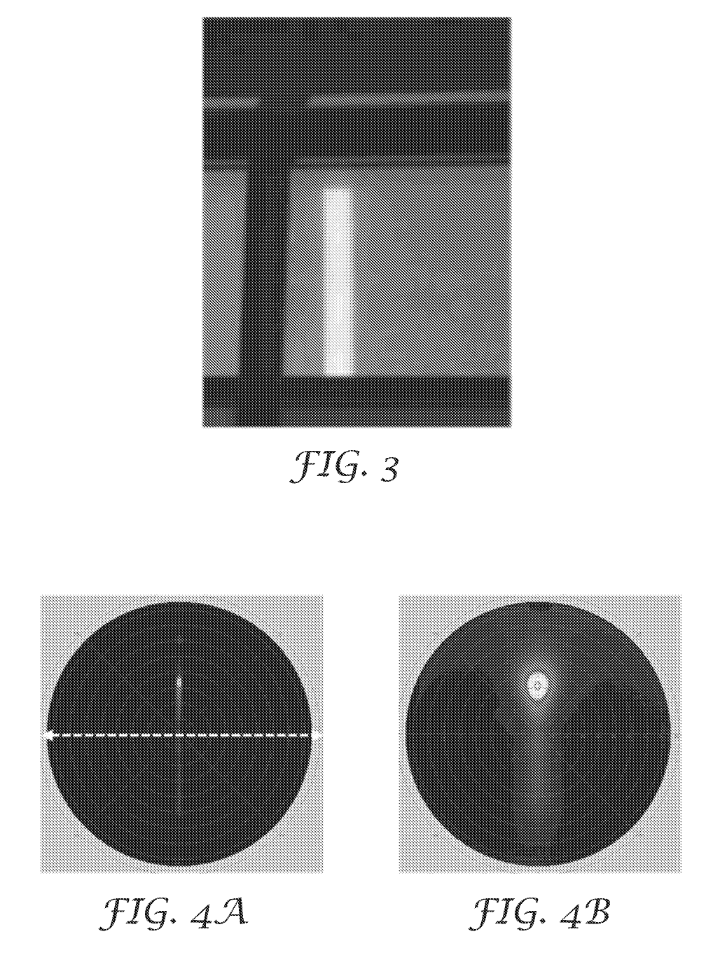

While one of the main incentives for using light redirecting films is energy savings, visual comfort needs to be taken in account. As shown in FIG. 1, while most of the sunlight 120 is directed upward as deflected light 124 a fraction goes downwards (not shown). This downward light can cause glare for the occupants. In addition since the microstructured prismatic elements are typically linear and oriented horizontally the incoming rays are refracted/reflected mainly in the vertical direction. Sunlight is highly collimated with about 0.5 degree spread and appears as a solar disk. The effect of the light redirecting film is to spread this light vertically to form a solar column, such as that shown in FIG. 3, where the solar column appears as a white band.

A variety of articles have been developed to redirect sunlight to provide illumination within rooms. For example, the following patents and patent applications describe various light redirecting films and light redirecting microstructures: US Patent Publication No. 2008/0291541, titled “Light Redirecting Solar Control Film”, filed May 23, 2007 (Padiyath et al.) and pending US Patent Applications No. 61/287,360, titled “Light Redirecting Constructions” filed Dec. 17, 2009 (Padiyath et al), and 61/287,354, titled “Light Redirecting Film Laminate” filed Dec. 17, 2009 (Padiyath et al.); PCT Application Publication No. WO 2012/134787, titled “Hybrid Light Redirecting and Light Diffusing Constructions”, filed Mar. 12, 2012 (Padiyath et al.), U.S. Pat. No. 5,551,042, titled “Structured Films and Use Thereof for Daylight Illumination”, issued Aug. 27, 1996 (Lea, et al.), US Patent Publication No. 2014/0211331, titled “Multiple Sequenced Daylight Redirecting Layers”, filed Mar. 27, 2014 (Padiyath et al.), US Patent Publication No. 2014/0198390, titled “Dual-sided Daylight Redirecting Film”, filed Mar. 27, 2014 (Padiyath, et al.), US Patent Publication No. 2008/0292820, titled “Light Diffusing Solar Control Film”, filed May 23, 2007 (Padiyath, et al.), U.S. Pat. No. 6,456,437, titled “Optical Sheets Suitable for Spreading Light”, issued Sep. 24, 2002 (Lea, et al.) The light redirecting films and light redirecting microstructures disclosed in the patents and patent applications in this paragraph are herein incorporated by reference. In general, any light redirecting film or layer, including those mentioned in this paragraph, and others known in the art, can be used in the constructions of this disclosure.

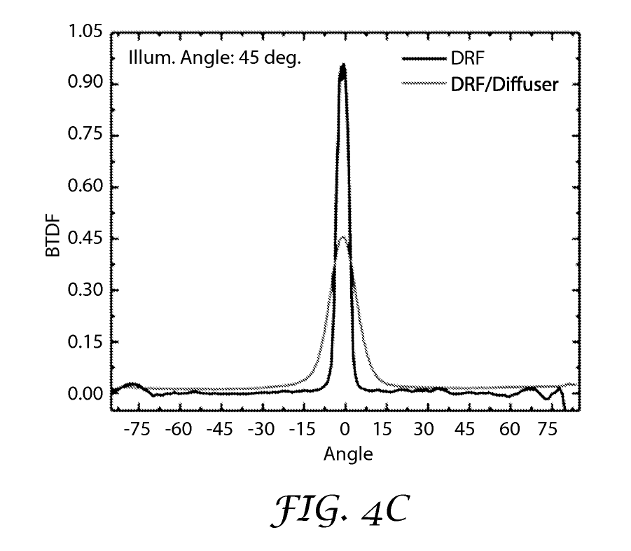

Both the total fraction of downward directed light and brightness of the solar column contribute to glare (visual discomfort). The brightness of the solar column depends on its angular spread. One solution to reduce glare is to introduce a diffuser layer in the optical path. The diffuser helps to spread out the solar column. In addition the diffuser layer provides more uniform ceiling illumination by diffusing the upward directed light as shown in FIG. 4. The light output distribution of bare light redirecting film, as shown in FIG. 4A, is compared with LRF/Diffuser (LRF before diffuser layer) at 45 degree illumination angle, shown in FIG. 4B. The diffuser layer spreads both the upward and downward directed light. The horizontal cross sections at 0 degree elevation are compared in FIG. 4B. The brightness of the solar column is proportional to the width and height of these peaks. The width of the peak increases and the peak height decreases by about two times with the addition of the diffuser. The use of the diffuser layer reduces glare and the visibility of the solar column significantly.

A variety of diffusers have been developed and are known in the art. For example, the following patents and patent applications describe various type of diffusers: U.S. Patent Publication No. 2014/0104689, titled “Hybrid Light Redirecting and Light Diffusing Constructions, filed Dec. 5, 2013, (Padiyath, et al.); PCT Application Publication No. WO 2014/093119, titled “Brightness Enhancing Film with Embedded Diffuser”, filed Dec. 5, 2013, (Boyd et al.); U.S. Pat. No. 6,288,172, titled “Light Diffusing Adhesive”, issued Sep. 11, 2001 (Goetz, et al.); PCT Application Publication No. WO 2013/158475, titled “Brightness Enhancement Film with Substantially Non-imaging Embedded Diffuser”, filed Apr. 12, 2013, (Boyd, et al.) The diffusers disclosed in the patents and patent applications in this paragraph are herein incorporated by reference. In general, any diffuser or diffusive layer, including those mentioned in this paragraph, and others known in the art, can be used in the constructions of this disclosure.

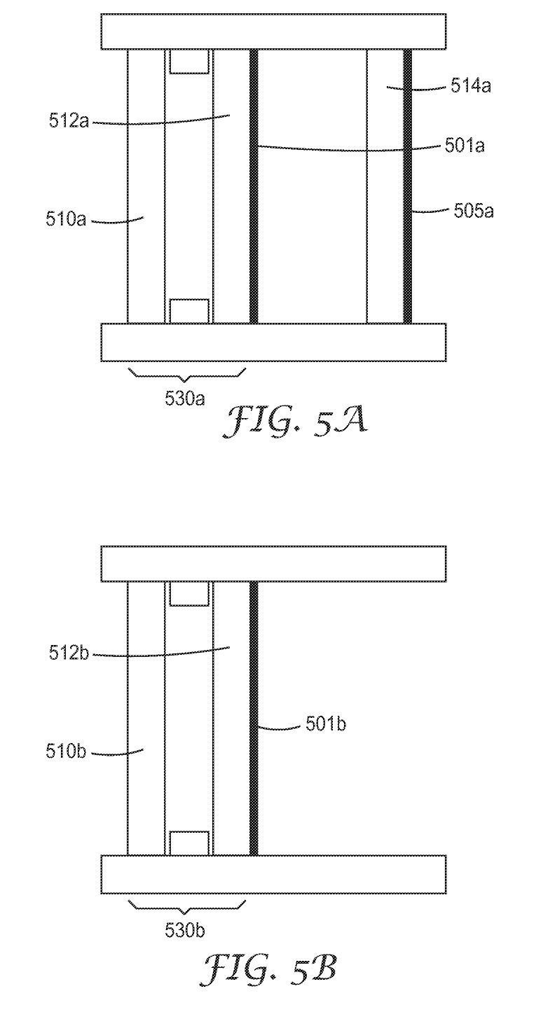

One option to combine the effect of a diffuser layer with a light redirecting film is to adhere the light redirecting film 501a to the window 512a and mount the diffuser 505a to an added pane 514a, as shown in FIG. 5A. The present disclosure presents a solution where the diffuser layer and the light redirecting film are in a single construction 501b, as shown in FIG. 5B.

In some embodiments, the diffusing properties can lie with the barrier elements, the adhesive, the window film adhesive, or any of the substrates that may be part of the light redirecting construction. In certain embodiments, the diffusing properties of any of the elements mentioned in the preceding sentence may be modified by introducing surface roughness, bulk diffusion, or using embedded diffusers.

In certain embodiments, the surface of a layer part of a light redirecting construction can be treated in such a manner that the layer diffuses visible light. Surface roughness to create diffusing properties in a layer can be accomplished by imparting a pattern on the surface of a layer that increases the angular spread of input light in a desired manner. Some methods used to impart such a pattern include embossing, replication, and coating.

In other embodiments, bulk diffusion can be accomplished by adding one or more diffusing agents to the window film adhesive. Diffusing agents can comprise opaque particles or beads.

Examples of diffusing agents include: polymeric or inorganic particles and/or voids included in a layer.

In yet other embodiments, a substrate or a layer part of a light redirecting construction can contain embedded diffusers. An embedded diffuser layer is formed in between the light redirecting layer and the substrate. This layer may consist of a matrix with diffusing agents. Alternatively the layer may be a surface diffuser layer consisting of a material with a refractive index sufficiently different from the light redirecting layer to obtain a desired level of diffusion. In other embodiments, various types of diffusers may also be used in combination.

Barrier Elements

One solution to form an assembly between a light redirecting film and a second film, such as a diffuser, involves “barrier elements,” also called “passivation islands.” In this approach a base film or liner is typically coated with a continuous layer of adhesive, for example a pressure sensitive adhesive (PSA), a hot melt, a thermoset adhesive, or a UV-curable adhesive. The adhesive layer is then printed with “barrier elements” or “islands” comprising a curable, non-tacky ink. Exposed regions of the adhesive remain tacky while the regions with the printed barrier elements are typically hard, and non-tacky. That is, the adhesive is passivated in those regions.

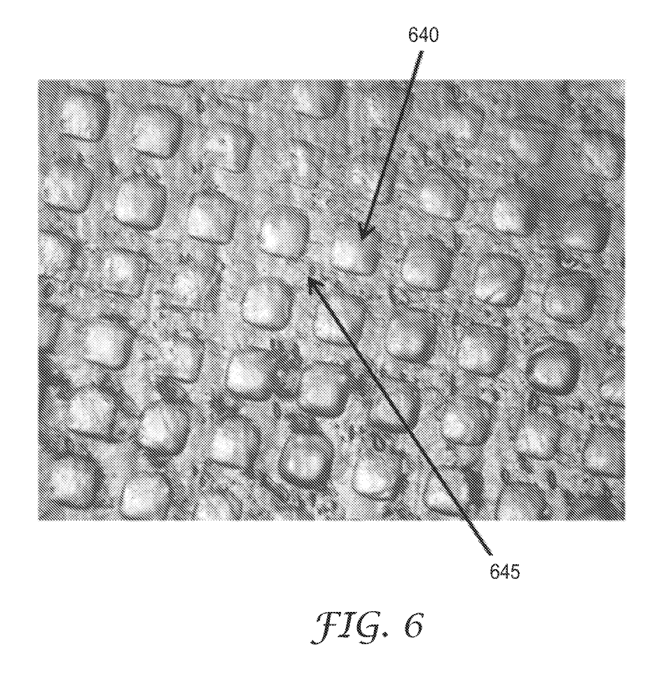

FIG. 6 shows an example in which barrier elements 640 have been printed on an adhesive 645. The square portions represent the barrier elements and the channel-like areas surrounding the barrier elements are made of the non-printed adhesive.

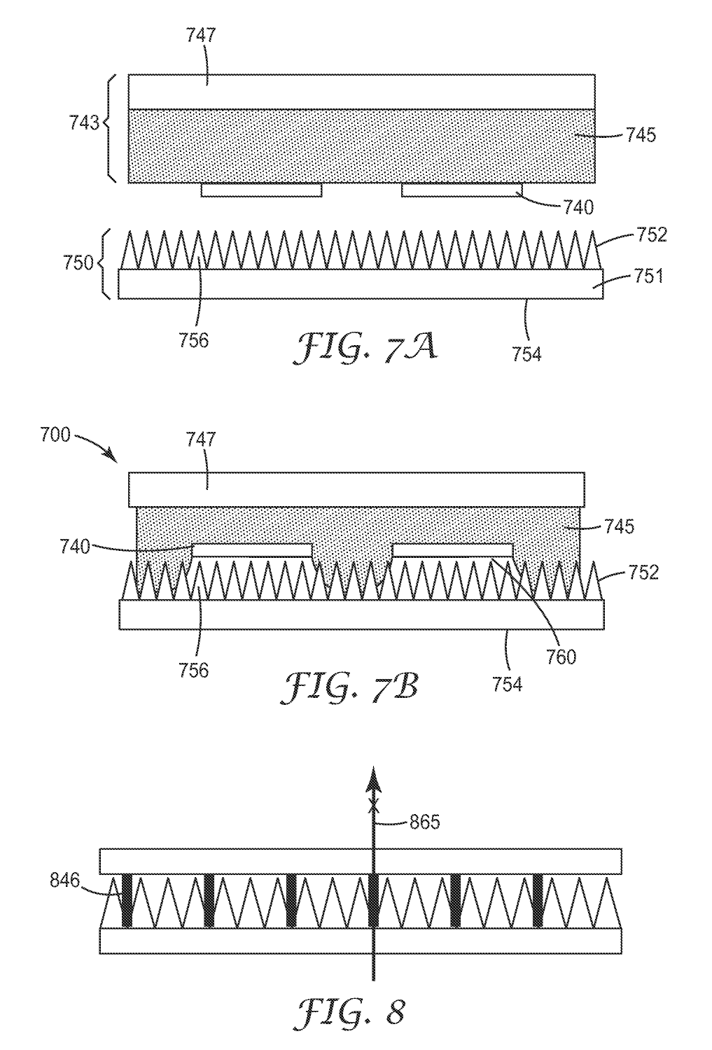

In one embodiment, the film with the printed barrier elements can be laminated to the light redirecting film. Lamination typically occurs under heat and pressure to allow the adhesive to flow into the microstructured prismatic elements. The two films are bonded in the regions with exposed, unprinted adhesive. FIG. 7A-7B is a schematic diagram of a typical process to bond a microstructured film to a second film. A light redirecting layer 750 having opposing first and second major surfaces 752 and 754 is provided and a film 743 including barrier elements 740 disposed on an adhesive layer 745 and including a liner 747 is provided. The light redirecting layer 750 includes microstructured prismatic elements 756 on film 751. The film 743 is laminated to the light redirecting layer 750 to form article 700 shown in FIG. 7B. Trapped air 760 is present between the barrier elements 740 and the light redirecting elements 756. Each of barrier elements 740, light redirecting elements 756, and adhesive layer 745 are typically formed from transparent materials.

The microstructured prismatic elements 756 of a light redirecting film, typically formed from resins, require an air interface to function. The barrier elements 740 prevent the adhesive 745 from flowing into the microstructured prismatic elements in those regions and maintain an air interface. This situation can be seen in FIG. 7B. The microstructured prismatic elements 756 retain their optical performance in those areas where trapped air 760 maintains an air interface with the microstructured prismatic elements. In the bonded regions the adhesive “wets” out the microstructured prismatic elements and their optical performance (e.g., their ability to redirect light) may be degraded. Light incident on these areas may not be redirected but instead would pass right through the construction. This phenomenon is referred to as punch through. In one embodiment, punch through 865 could be eliminated if an opaque adhesive 846 is used in the areas where the adhesive is in contact with the microstructured prismatic elements, as shown in FIG. 8.

The optical performance of the assembly may be optimized by maximizing the ratio of the area of barrier elements to the area of exposed adhesive. As mentioned before, the adhesion between the two substrates, measured in peel strength, is proportional to the exposed adhesive area. The required peel strength is dependent on the specific application. The peel strength and the optical performance of the assembly must be balanced when determining the area exposed to adhesive. In addition, for applications such as light redirecting films, the aesthetics of the pattern should also be taken into account because, not only the size of the area exposed to adhesive, but also the location of those regions within the entire film can affect how a user perceives the construction.

In certain embodiments, the peel strength for the bond between a the layer bonded to the light redirecting layer, such as a first substrate, and the light redirecting layer is from 25 g/in to 2,000 g/in. In other embodiments, the peel strength for the bond between the first substrate and the light redirecting layer is greater than 300 g/in, or greater than 400 g/in, or greater than 500 g/in.

In some embodiments, the barrier element diffuses visible light. As mentioned before, diffusion can be accomplished by creating surface diffusers, bulk diffusers, and embedded diffusers.

In other embodiments, the barrier elements can comprise one or more light stabilizers in order to enhance durability, for example in environments exposed to sunlight. These stabilizers can be grouped into the following categories: heat stabilizers, UV light stabilizers, and free-radical scavengers. Heat stabilizers are commercially available from Witco Corp., Greenwich, Conn. under the trade designation “Mark V 1923” and Ferro Corp., Polymer Additives Div., Walton Hills, Ohio under the trade designations “Synpron 1163”, “Ferro 1237” and “Ferro 1720”. In some embodiments, such heat stabilizers can be present in amounts ranging from 0.02 to 0.15 weight percent. In one embodiment, UV light stabilizers can be present in amounts ranging from 0.1 to 5 weight percent. Benzophenone-type UV-absorbers are commercially available from BASF Corp., Parsippany, N.J. under the trade designation “Uvinol 400”; Cytec Industries, West Patterson, N.J. under the trade designation “Cyasorb UV1164” and Ciba Specialty Chemicals, Tarrytown, N.Y., under the trade designations “Tinuvin 900”, “Tinuvin 123” and “Tinuvin 1130”. In certain embodiments, free-radical scavengers can be present in an amount from 0.05 to 0.25 weight percent. Nonlimiting examples of free-radical scavengers include hindered amine light stabilizer (HALS) compounds, hydroxylamines, sterically hindered phenols, and the like. HALS compounds are commercially available from Ciba Specialty Chemicals under the trade designation “Tinuvin 292” and Cytec Industries under the trade designation “Cyasorb UV3581.”

Patterns for the Barrier Elements

In certain window film applications, such as those that contemplate a light redirecting film with a diffuser in a single construction, it may be desirable to minimize the visibility of the barrier elements. This may be achieved by judicious selection of the pattern in which the barrier elements are printed on the adhesive. Based on the inventors' experience, the following are some factors that affect pattern visibility based on considerations of the human visual system include:
Minimizing barrier elements size;
Avoiding long continuous edges or channels that have no interruptions; and
Minimizing adhesive linewidths.

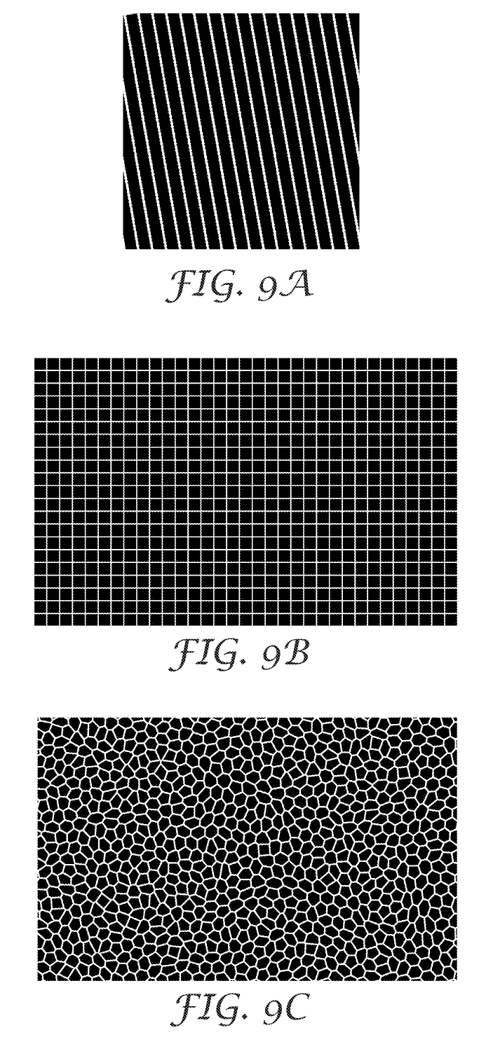

FIG. 9 shows three different sample patterns 9A, 9B, and 9C. The black areas represent the barrier elements while the white areas represent the exposed adhesive. FIG. 9A represents a 1-dimmensional pattern consisting of lines. The lines may be oriented in any direction. When laminated to the structured film, this construction would not be fully sealed due to air ingress provided by the barrier elements in the black areas. A full seal may still be achieved by providing an exposed adhesive border or by edge-sealing the laminate.

In general, the barrier elements can be laid out in a pattern chosen from a repeating 1-dimensional pattern, a repeating 2-dimensional pattern, and a random-looking 1- or 2-dimensional pattern.

A fully sealed construction may also be achieved by using a 2-dimensional pattern as shown in FIG. 9B, where air ingress in blocked by the exposed adhesive shown as white lines. That pattern is an example of an ordered grid pattern consisting of a rectangular array of squares. FIG. 9C shows barrier elements in the shape of random-looking polygons. The pattern of 9C also prevents air ingress due to the exposed adhesive shown in white and may be less visible to the human eye compared to FIG. 9B due to the breakup of the long straight edges present in pattern 9B. The edges in the 2-dimensional patterns may be straight or have curves. Other patterns could include random or ordered arrays of dots or decorative features.

The patterns in FIG. 9 may be characterized by two independent parameters:
the pitch, which is meant to represent the center-to-center distance between corresponding barrier elements. For random-looking structures, such as those in FIG. 9C, the pitch may represent the average distance between the centers of adjacent polygons. In certain embodiments, the average pitch in the construction is from 0.035 millimeters to 100 millimeters. In other embodiments, the average pitch in the article is from 0.1 millimeters to 10 millimeters, or from 0.5 millimeters to 5 millimeters, or from 0.75 millimeters to 3 millimeters. In the inventors view, patterns with smaller pitches may be less visible; and
Coverage, which is understood as the ratio of the total surface area of barrier element area to the total area. The total area refers to the area defined by the microstructured prismatic elements that form the light redirecting film. For that reason, in this disclosure, the total surface area is also called the light redirecting area. Patterns with higher coverage may have less “punch through” while patterns with lower coverage may have higher peel strength.

In some embodiments, the total surface area of the barrier elements is greater than 50% of the light redirecting area. In other embodiments, the total surface area of the barrier elements is greater than 60%, or greater than 65%, or greater than 70%, or greater than 75%, or greater than 80%, or greater than 85%, or greater than 90%, or greater than 95%, or greater than 98%, of the light redirecting area

The gap, which represents the exposed adhesive width between barrier elements may be deduced once the pitch and coverage are known. In some embodiments, the average gap in the construction is from 0.01 millimeters to 40 millimeters. In other embodiments, the average gap in the construction is from 0.05 mm to 20 mm; or from 0.1 mm to 20 mm; or from 0.2 mm to 20 mm. For reference, both patterns in the left and center panels in FIG. 9 have about 80% coverage.

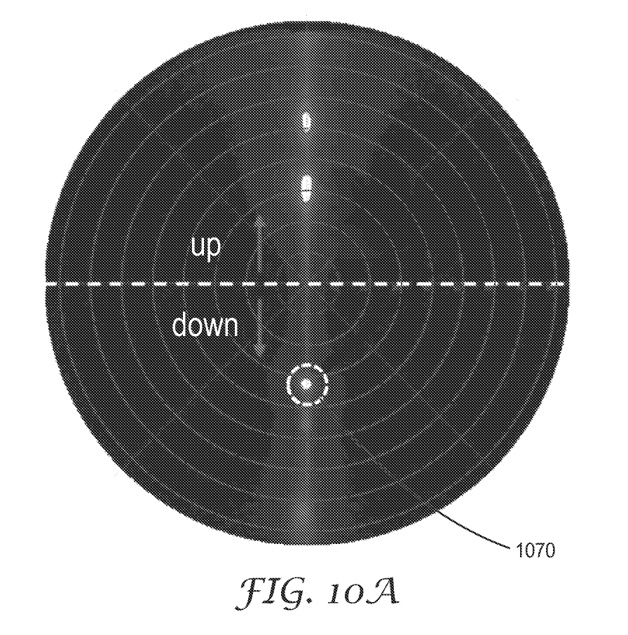

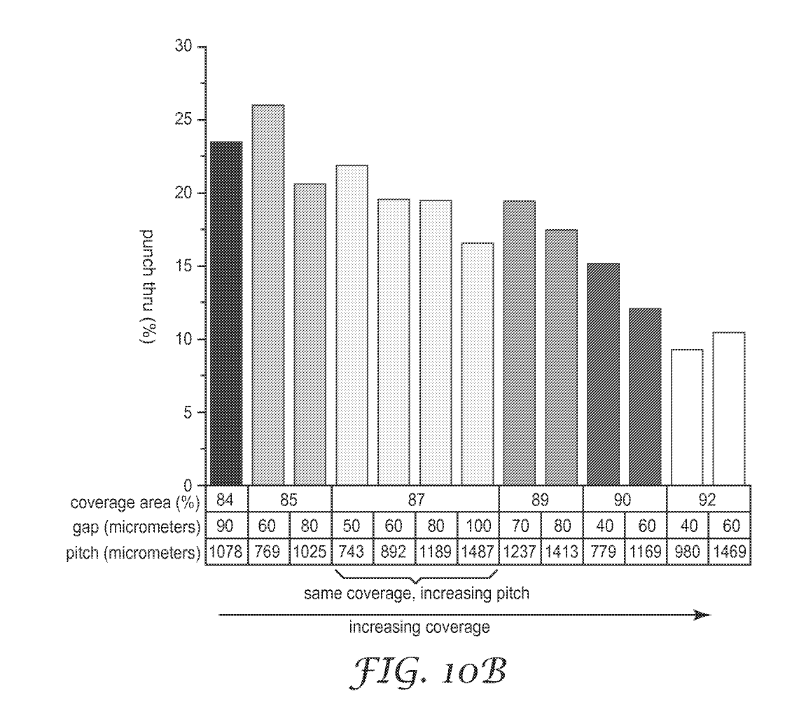

The “punch through” glare 1070 from single-film light redirecting film/diffuser constructions with random-looking polygon barrier elements having varying pitch and coverage is shown in FIG. 10A. Punch through degrades redirection performance. As shown in FIG. 10B, higher coverage patterns result in decreased punch through. However, bond strength between the films in the assembly may be reduced as the area covered by the barrier elements is increased.

Pattern visibility is also determined by feature sizes: size of the barrier elements (related to pattern pitch) and gap widths. The gap visibility is determined by the gap width and the viewing distance. Gap visibility may be estimated based on the resolution of the human visual system for a given viewing distance.

Inks for the Barrier Elements

The patterns of barrier elements may be printed by direct or offset printing using a variety of known printing methods such as flexographic printing, gravure printing, screen printing, letterpress printing, lithographic printing, ink-jet printing, digitally controlled spraying, thermal printing, and combinations thereof. For direct printing methods, barrier elements printed by flexographic printing can have thickness up to 10 micrometers, by gravure printing, thickness can be up to 30 micrometers, and by screen printing, the thickness can be up to 500 um. The inks are typically printed in liquid form and then cured in place. Curing methods can include UV, E-beam, chemical, thermal curing, or cooling. Durability of the ink may be increased by additives such as light stabilizers.

In general, any material that prevents the adhesive from contacting the microstructured prismatic elements, by reducing or stopping flowing or creeping can be used as an ink for the barrier elements. Exemplary materials for use in barrier elements include resins, polymeric materials, dyes, inks, vinyl, inorganic materials, UV-curable polymers, pigments, particles, and beads.

The optical properties of the ink may also be adjusted by modifying the ink's refractive index and/or its diffusing characteristics. The diffusing properties of the ink may be modified, for example by introducing surface roughness or bulk diffusers. In some embodiments, a barrier element with diffusion is used to prepare a light redirecting construction with both clear view-through regions and light redirecting regions, such as the light redirecting construction 1100 exemplified in FIG. 11.

Construction 1100 includes a light redirecting layer 1150 having opposing first and second major surfaces 1152 and 1154 where the first surface 1152 includes one or more microstructured prismatic elements 1156, adhesive layer 1145, and one or more barrier elements 1140 disposed on the adhesive layer 1145. The adhesive layer 1145 has a first major surface 1146 and a second major surface 1147. The first major surface 1146 of the adhesive layer 1145 has a first region 1148 and a second region 1149. The first region 1148 of the first surface 1146 of the adhesive layer 1145 is in contact with one or more barrier elements 1140. The second region 1149 of the first surface 1146 of the adhesive layer 1145 is in contact with one or more microstructured prismatic elements 1156. The one or more microstructured prismatic elements 1156 defines a light redirecting area, which in the illustrated embodiment is substantially the area of second major surface 1154. The total surface area of the one or more barrier elements 1140 is greater than 60% of the light redirecting area.

In the embodiment of FIG. 11, the diffuser is integrated in the barrier elements 1140. Regions 1149 in which the adhesive wets out the microstructures would provide clear view through areas 1175. Light ray 1165 is incident on light redirecting layer 1150 in the region where first major surface 1152 is exposed to air. This light ray 1165 is deflected by the microstructured prismatic elements 1156, is scattered (diffused) by the barrier elements 1140, and then exits the construction 1100. Light ray 1173 is incident on light redirecting layer 1150 near clear view through areas 1175. Light ray 1173 passes through construction 1100 with little scattering. Blurriness in these regions could be reduced by matching the refractive index of the microstructured prismatic elements to the refractive index of the adhesive. In certain embodiments, clear view through regions could be desirable to provide visibility past the construction.

Adhesives

In certain embodiments, the adhesives used to laminate the two films in constructions according to this disclosure, have the following characteristics:

a) the adhesive flows into the microstructured prismatic elements under suitable conditions, for example those used to laminate the two films. Suitable conditions, such as lamination, typically include heat, pressure, and, if performed in roll-to-roll operations, a certain line speed. The flow properties and thickness of the adhesive relative to the microstructured prismatic elements may be adjusted as needed. Adhesive properties that could influence flow include molecular weight, cross link density, and additives, such as plasticizers;

b) the adhesive is resistant to “creep” under the conditions used to store, apply, and use the product; and

c) the adhesive is durable under UV exposure and thermal conditions encountered. In some embodiments, UV stabilizers, such as a UV absorber (UVA) or hindered amine light stabilizer (HALS), may be added to the adhesive.

Ultraviolet absorbers function by preferentially absorbing ultraviolet radiation and dissipating it as thermal energy. Suitable UVAs may include: benzophenones (hydroxybenzophenones, e.g., Cyasorb 531 (Cytec)), benzotriazoles (hydroxyphenylbenzotriazoles, e.g., Cyasorb 5411, Tinuvin 329 (Ciba Geigy)), triazines (hydroxyphenyltriazines, e.g., Cyasorb 1164), oxanilides, (e.g., Sanuvor VSU (Clariant)) cyanoacrylates (e.g., Uvinol 3039 (BASF)), or benzoxazinones. Suitable benzophenones include, CYASORB UV-9 (2-hydroxy-4-methoxybenzophenone, CHIMASSORB 81 (or CYASORB UV 531) (2 hyroxy-4 octyloxybenzophenone). Suitable benzotriazole UVAs include compounds available from Ciba, Tarrytown, N.Y. as TINUVIN P, 213, 234, 326, 327, 328, 405 and 571, and CYASORB UV 5411 and CYASORB UV 237. Other suitable UVAs include CYASORB UV 1164 (2-[4,6-bis(2,4-dimethylphenyl)-1,3,5-triazin-2yl]-5(oxctyloxy) phenol (an exemplary triazine) and CYASORB 3638 (an exemplary benzoxiazine).

Hindered amine light stabilizers (HALS) are efficient stabilizers against light-induced degradation of most polymers. HALS do not generally absorb UV radiation, but act to inhibit degradation of the polymer. HALS typically include tetra alkyl piperidines, such as 2,2,6,6-tetramethyl-4-piperidinamine and 2,2,6,6-tetramethyl-4-piperidinol. Other suitable HALS include compounds available from Ciba, Tarrytown, N.Y. as TINUVIN 123, 144, and 292.

The UVAs and HALS disclosed explicitly here are intended to be examples of materials corresponding to each of these two categories of additives. The present inventors contemplate that other materials not disclosed here but known to those skilled in the art for their properties as UV absorbers or hindered amine light stabilizers can be used in the constructions of this disclosure.

In some embodiments, where it is desirable for a user to be able to see through certain regions of the construction, the refractive index of the material of the microstructured prismatic elements matches the refractive index of the adhesive layer

In certain embodiments, the adhesive in the adhesive layer is chosen from a pressure sensitive adhesive, a thermoset adhesive, hot melt adhesive, and a UV-curable adhesive.

Exemplary pressure sensitive adhesives for use in the articles of the present disclosure include crosslinked tackified acrylic pressure-sensitive adhesives. Other pressure sensitive adhesives such as blends of natural or synthetic rubber and resin, silicone or other polymer systems, with or without additives can be used. The PSTC (pressure sensitive tape council) definition of a pressure sensitive adhesive is an adhesive that is permanently tacky at room temperature, which adheres to a variety of surfaces with light pressure (finger pressure) with no phase change (liquid to solid).

Acrylic Acid and Meth(acrylic) Acid Esters: The acrylic esters are present at ranges of from about 65 to about 99 parts by weight, for example from about 78 to about 98 parts by weight, and in some embodiments from about 90 to about 98 parts by weight. Useful acrylic esters include at least one monomer selected from the group consisting of a first monofunctional acrylate or methacrylate ester of a non-tertiary alkyl alcohol, the alkyl group of which comprises from 4 to about 12 carbon atoms, and mixtures thereof. Such acrylates or methacrylate esters generally have, as homopolymers, glass transition temperatures below about −25° C. A higher amount of this monomer relative to the other comonomers affords the PSA higher tack at low temperatures.

Examples of acrylate or methacrylate ester monomers include, but are not limited to, those selected from the group consisting of n-butyl acrylate (BA), n-butyl methacrylate, isobutyl acrylate, 2-methyl butyl acrylate, 2-ethylhexyl acrilate, n-octyl acrylate, isooctyl acrylate (IOA), isooctyl methacrylate, isononyl acrylate, isodecyl acrylate, and mixtures thereof.

In some embodiments, the acrylates include those selected from the group consisting of isooctyl acrylate, n-butyl acrylate, 2-methyl butyl acrylate, 2-ethylhexyl acrylate, and mixtures thereof.

Polar Monomers: Low levels of (typically about 1 to about 10 parts by weight) of a polar monomer such as a carboxylic acid can be used to increase the cohesive strength of the pressure-sensitive adhesive. At higher levels, these polar monomers tend to diminish tack, increase glass transition temperature and decrease low temperature performance.

Useful copolymerizable acidic monomers include, but are not limited to, those selected from the group consisting of ethylenically unsaturated carboxylic acids, ethylenically unsaturated sulfonic acids, and ethylenically unsaturated phosphonic acids. Examples of such monomers include those selected from the group consisting of acrylic acid (AA), methacrylic acid, itaconic acid, fumaric acid, crotonic acid, citraconic acid, maleic acid, beta-carboxyethyl acrylate, sulfoethyl methacrylate, and the like, and mixtures thereof.

Other useful copolymerizable monomers include, but are not limited to, (meth)acrylamides, N,N-dialkyl substituted (meth)acrylamides, N-vinyl lactams, and N,N-dialkylaminoalkyl(meth)acrylates. Illustrative examples include, but are not limited to, those selected from the group consisting of N,N-dimethyl acrylamide, N,N-dimethyl methacrylamide, N,N-diethyl acrylamide, N,N-diethyl methacrylamide, N,N-dimethylaminoethyl methacrylate, N,N-dimethylaminopropyl methacrylate, N,N-dimethylaminoethyl acrylate, N,N-dimethylaminopropyl acrylate, N-vinyl pyrrolidone, N-vinyl caprolactam, and the like, and mixtures thereof.

Non-polar Ethylenically Unsaturated Monomers: The non-polar ethylenically unsaturated monomer is a monomer whose homopolymer has a solubility parameter as measured by the Fedors method (see Polymer Handbook, Bandrup and Immergut) of not greater than 10.50 and a Tg greater than 15° C. The non-polar nature of this monomer tends to improve the low energy surface adhesion of the adhesive. These non-polar ethylenically unsaturated monomers are selected from the group consisting of alkyl(meth)acrylates, N-alkyl(meth)acrylamides, and combinations thereof. Illustrative examples include, but are not limited to, 3,3,5-trimethylcyclohexyl acrylate, 3,3,5-trimethylcyclohexyl methacrylate, cyclohexyl acrylate, cyclohexyl methacrylate, isobornyl acrylate, isobornyl methacrylate, N-octyl acrylamide, N-octyl methacrylamide or combinations thereof. Optionally, from 0 to 25 parts by weight of a non-polar ethylenically unsaturated monomer may be added.

Tackifiers: In some embodiments, tackifiers are added to the adhesive and can include terpene phenolics, rosins, rosin esters, esters of hydrogenated rosins, synthetic hydrocarbon resins and combinations thereof. These provide good bonding characteristics on low energy surfaces. Hydrogenated rosin esters and hydrogenated C9 aromatic resins are useful tackifiers in some embodiments, because of performance advantages that include high levels of “tack”, outdoor durability, oxidation resistance, and limited interference in post crosslinking of acrylic PSAs.

Tackifiers may be added at a level of about 1 to about 65 parts per 100 parts of the monofunctional acrylate or methacrylate ester of a non-tertiary alkyl alcohol, the polar monomer, and the nonpolar ethylenically unsaturated monomer to achieve desired “tack”. Preferably, the tackifier has a softening point of about 65 to about 100.degree. C. However, the addition of tackifiers can reduce shear or cohesive strength and raise the Tg of the acrylic PSA, which is undesirable for cold temperature performance.

Crosslinkers: In one embodiment, crosslinkers are added to the adhesive. In order to increase the shear or cohesive strength of acrylic pressure-sensitive adhesives, a crosslinking additive may be incorporated into the PSA. Two main types of crosslinking additives are commonly used. The first crosslinking additive is a thermal crosslinking additive such as a multifunctional aziridine. One example is 1,1′-(1,3-phenylene dicarbonyl)-bis-(2-methylaziridine) (CAS No. 7652-64-4), referred to herein as “bisamide”. Such chemical crosslinkers can be added into solvent-based PSAs after polymerization and activated by heat during oven drying of the coated adhesive.

In another embodiment, chemical crosslinkers that rely upon free radicals to carry out the crosslinking reaction may be employed. Reagents such as, for example, peroxides serve as a source of free radicals. When heated sufficiently, these precursors will generate free radicals, which bring about a crosslinking reaction of the polymer. A common free radical generating reagent is benzoyl peroxide. Free radical generators are required only in small quantities, but generally require higher temperatures to complete the crosslinking reaction than those required for the bisamide reagent.

In certain embodiments, the adhesive can be a heat-activated adhesive, such as hot-melt adhesive. Heat-activated adhesives are non-tacky at room temperature but become tacky and capable of bonding to a substrate at elevated temperatures. These adhesives usually have a glass transition temperature (Tg) or melting point (Tm) above room temperature. When the temperature is increased above the Tg or Tm, the storage modulus usually decreases and the adhesive becomes tacky.

In some embodiments, the adhesive diffuses visible light. As mentioned before, diffusion can be accomplished by creating surface diffusers, bulk diffusers, and embedded diffusers.

Light Redirecting Film Configurations

### Room-Facing Configurations

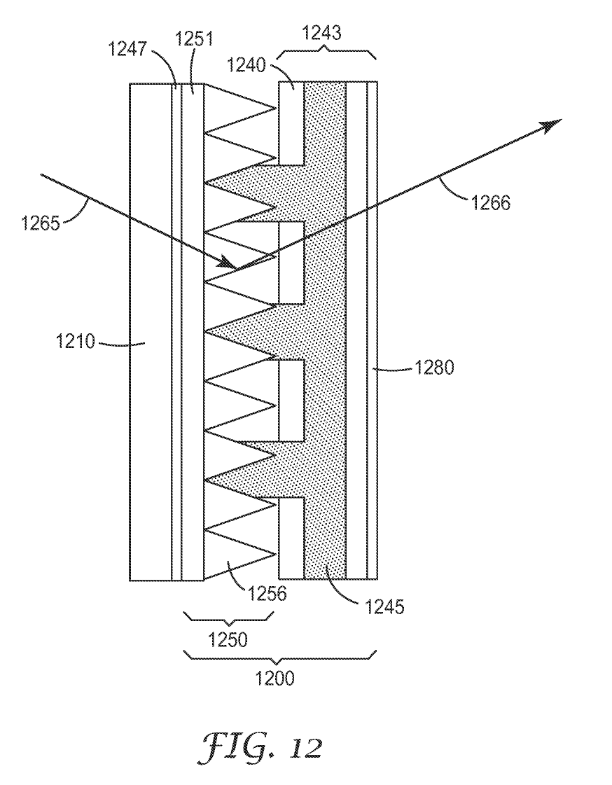

A room-facing light redirecting assembly 1200 is shown in FIG. 12. In this embodiment, a daylight redirecting film 1250 with the light redirecting microstructures 1256, which are disposed on substrate 1251, oriented towards the room is bonded to the cover/diffusing film 1243 using the barrier elements approach. The cover film 1243 may include diffusing properties depending on the optical performance of the light redirecting microstructure. In the illustrated embodiment, the cover film 1243 includes barrier elements 1240, adhesive 1245, and diffuser 1280. Diffuser 1280 is illustrated as a layer on the room-facing surface of assembly 1200. In other embodiments, the diffuser may be integrated into substrate 1251 or may be included in or on another substrate or in or on the barrier elements 1240. The diffuser 1280 may be a surface, bulk, and/or embedded diffuser. In some embodiments, the diffuser 1280 is a surface diffuser, which may be an asymmetric or anisotropic surface diffuser as described further elsewhere herein. Diffusion may also be included in the adhesive and/or the barrier elements. The assembly 1200 may be mounted to a window or glazing 1210 using window film adhesive 1247. FIG. 12 illustrates incoming sunlight ray 1265 which is deflected by structures 1256 as it passes through the light redirecting assembly. The light ray exits the light redirecting assembly 1200 as deflected light ray 1266. Although not explicitly shown in FIG. 12, a portion of the light passing though the light redirecting assembly 1200 would typically be scattered by diffuser 1280 after being deflected by light redirecting layer 1250.

In certain embodiments, the present disclosure is directed to a film comprising an article, wherein the article comprises:
a light redirecting layer comprising a first major surface and a second major surface;
   wherein the light redirecting layer comprises one or more microstructured prismatic elements on its first major surface defining a light redirecting area;
one or more barrier elements;
   wherein the total surface area of the one or more barrier elements is greater than 90% of the light redirecting area;
an adhesive layer;
   wherein the adhesive layer comprises a first major surface and a second major surface;
   wherein the first major surface of the adhesive layer has a first region and a second region;
   wherein the first region of the first surface of the adhesive layer is in contact with one or more barrier elements;
   wherein the second region of the first surface of the adhesive layer is in contact with one or more microstructured prismatic elements;
a first substrate adjacent the second major surface of the adhesive layer;
   wherein the first substrate is a diffuser; and
a window film adhesive layer adjacent the second surface of the light redirecting layer;
wherein the article allows transmission of visible light;
wherein the film optionally further comprises a liner immediately adjacent the window film adhesive layer.

### Sun-Facing Configurations

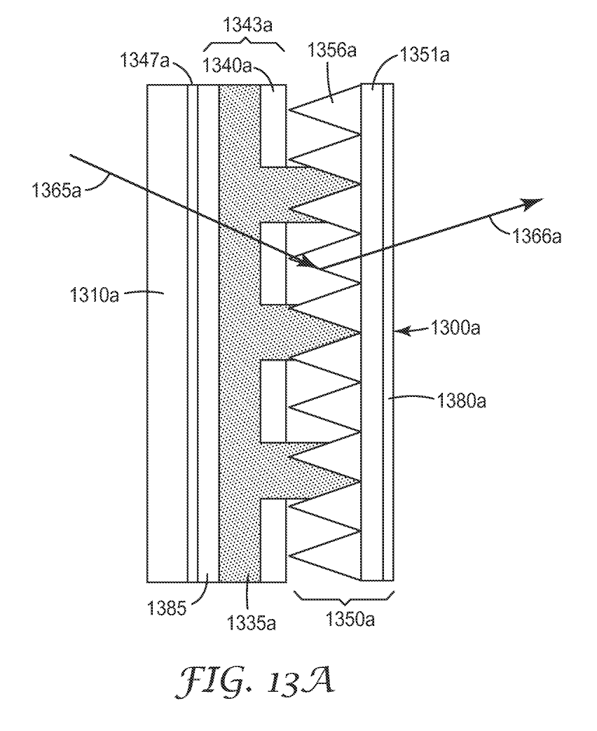

Sun-facing light redirecting configurations are shown in FIGS. 13A-13B. FIG. 13A shows assembly 1300a including light redirecting layer 1350a having light redirecting microstructures 1356a, which are disposed on substrate 1351a, and diffuser 1380a, cover film 1343a including barrier elements 1340a, adhesive 1335a, and substrate 1385. The cover film 1343a is laminated to the light redirecting layer 1350a using the barrier element approach. The assembly 1300a is attached to the window or glazing 1310a through window film adhesive 1347a. Incoming sunlight ray 1365a and outgoing redirected light ray 1366a are illustrated in FIG. 13A. Diffuser 1380a is illustrated as surface layer on substrate 1351a. In other embodiments, the diffuser may be integrated into substrate 1351a or may be included in or on another substrate or in or on the barrier elements 1340a. FIG. 13B shows assembly 1300b including light redirecting layer 1350b having light redirecting microstructures 1356b, which are disposed on substrate 1351b, and diffuser 1380b, cover film 1343b including barrier elements 1340b, and adhesive 1345. The cover film 1343b is laminated to the light redirecting layer 1350b using the barrier element approach. The assembly 1300b is attached to the window or glazing 1310b through adhesive 1345. Incoming sunlight ray 1365b and outgoing redirected light ray 1366b are illustrated in FIG. 13B. Diffuser 1380b is illustrated as surface layer on substrate 1351b. In other embodiments, the diffuser may be integrated into substrate 1351b or may be included in or on another substrate or in or on the barrier elements 1340b.

In both embodiments, the microstructures 1356a and 1356b are oriented towards the incoming sunlight. In these embodiments, the microstructure substrate 1351a or 1351b may also have diffusing properties integrated into it. In certain embodiments, diffusive properties can be achieved by coating a surface diffuser on the substrate side opposing the microstructured prismatic elements. This substrate could also include bulk diffusion properties. In FIG. 13A, the light redirecting substrate 1351a is bonded to a second substrate 1385 using the barrier elements approach. The substrate 1385 may have a window film adhesive 1347a coated on the opposing face to attach to a glazing 1310a.

In certain embodiments, the present disclosure is directed to a film comprising an article, wherein the article comprises:
a light redirecting layer comprising a first major surface and a second major surface;
   wherein the light redirecting layer comprises one or more microstructured prismatic elements on its first major surface defining a light redirecting area;
one or more barrier elements;
   wherein the total surface area of the one or more barrier elements is greater than 90% of the light redirecting area;
an adhesive layer;
   wherein the adhesive layer comprises a first major surface and a second major surface;
   wherein the first major surface of the adhesive layer has a first region and a second region;
   wherein the first region of the first surface of the adhesive layer is in contact with one or more barrier elements;
   wherein the second region of the first surface of the adhesive layer is in contact with one or more microstructured prismatic elements;

a diffuser adjacent the second major surface of the light redirecting layer;

a first substrate immediately adjacent the adhesive layer;

a window film adhesive layer immediately adjacent the first substrate;

wherein the article allows transmission of visible light;

wherein the film optionally further comprises a liner immediately adjacent the window film adhesive layer.

In FIG. 13B, the second substrate is eliminated and the bonding adhesive 1345 is used both to laminate the barrier elements 1340b to the microstructured prismatic elements 1356b and to attach the assembly 1300b to the glazing 1310b. This configuration is potentially a simpler, lower cost, and thinner construction. Incoming sunlight ray 1365b and outgoing redirected light ray 1366b are illustrated in FIG. 13B. Diffuser 1380b is illustrated as surface layer on substrate 1351b. In other embodiments, the diffuser may be integrated into substrate 1351b or may be included in or on another substrate or in or on the barrier elements 1340b.

In certain embodiments, the present disclosure is directed to a film comprising an article, wherein the article comprises:
a light redirecting layer comprising a first major surface and a second major surface;
   wherein the light redirecting layer comprises one or more microstructured prismatic elements on its first major surface defining a light redirecting area;
one or more barrier elements;
   wherein the total surface area of the one or more barrier elements is greater than 90% of the light redirecting area;
an adhesive layer;
   wherein the adhesive layer comprises a first major surface and a second major surface;
   wherein the first major surface of the adhesive layer has a first region and a second region;
   wherein the first region of the first surface of the adhesive layer is in contact with one or more barrier elements;
   wherein the second region of the first surface of the adhesive layer is in contact with one or more microstructured prismatic elements;
a diffuser adjacent the second major surface of the light redirecting layer;
wherein the article allows transmission of visible light;
wherein the film optionally further comprises a liner immediately adjacent the adhesive layer.

In some embodiments, the present disclosure is directed to a window comprising any of the films described above.

In certain embodiments, such as in the above room-facing and sun-facing constructions, diffusion may be incorporated in the substrates and/or adhesives. Diffusers may be surface, bulk, or embedded diffusers.

In some embodiments, the window film adhesive diffuses visible light. As mentioned before, diffusion can be accomplished by creating surface diffusers, bulk diffusers, and embedded diffusers.

In other embodiments, such as those disclosed in this section, it is useful to seal the edges of the light redirecting construction to prevent ingress of contaminants such as moisture and dirt. In those embodiments, one option to seal at least a portion of the edge is for the adhesive layer to fill the space between at least two immediately adjacent microstructured prismatic elements. In other embodiments, the entire edge can be sealed in this manner if the adhesive fills the space between the microstructured prismatic elements near the edge.

In some embodiments, the construction has a rectangular or square shape and the edge of one or more sides, up to all four sides, is sealed. In certain embodiments, the sealing can occur: by the use of a sealing agent, by the adhesive layer as described above, by using an edge sealing tape, or by using pressure, temperature, or some combination of both, including the use of a hot knife.

In other embodiments, the shape of the construction is circular or ellipsoidal shape and the edge of the construction is sealed all around. As mentioned before, the sealing can occur: by the use of a sealing agent, by the adhesive layer as described above, by using an edge sealing tape, or by using pressure, temperature, or some combination of both, including the use of a hot knife.

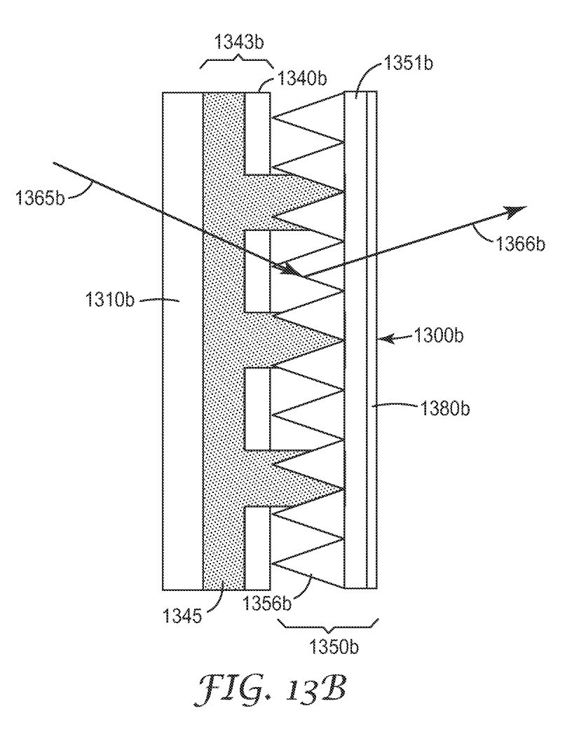

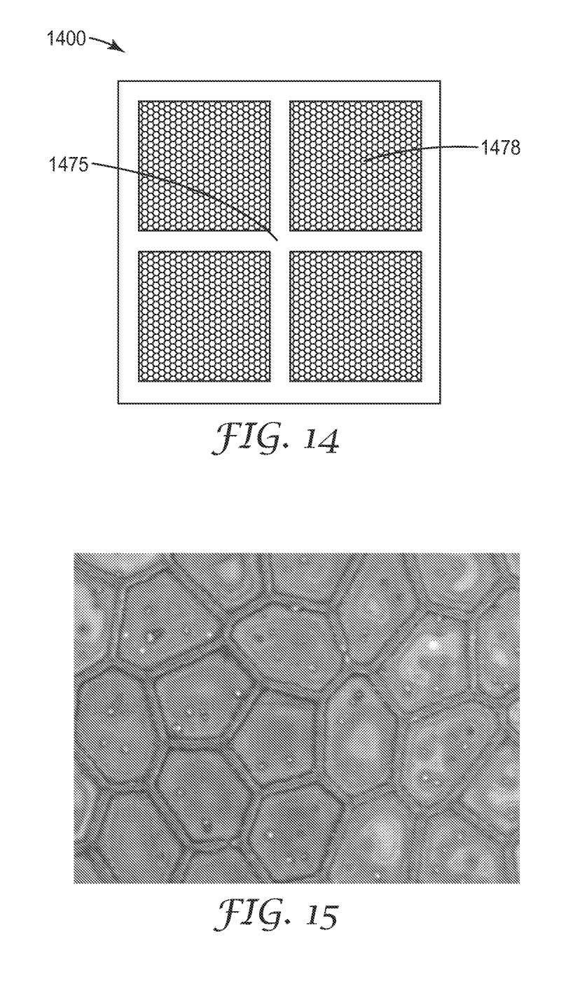

In other embodiments, the light redirecting construction can have: (a) a see-through region where the adhesive layer fills the space between adjacent microstructured prismatic elements such that no light redirecting occurs and light passes through the construction with no significant refraction, and (b) a light redirecting region as described in the embodiments disclosed above (that is, having barrier elements surrounded by the adhesive layer that bonds the light redirecting layer to a second layer or substrate). FIG. 14 shows an example of such an embodiment. In this embodiment, light redirecting construction 1400 includes see-through region 1475 and light redirecting regions 1478. In such embodiments, the barrier elements within the active light redirecting region 1478 may optionally be diffusive, for example by comprising a diffusing agent or a surface diffuser.

In yet other embodiments constructions as described in the preceding paragraph may have a diffuser (bulk, surface, or embedded) on what originally was a see-through region.

Methods of Making Light Redirecting Film Configurations

Another aspect of the present disclosure is directed to methods of making a light redirecting construction. In some embodiments, the method comprises:
providing a first substrate having a first major surface and a second major surface opposite the first major surface;
applying an adhesive layer to the first major surface of the first substrate;
   wherein the adhesive layer has a first major surface and a second major surface opposite the first major surface; and wherein the second major surface of the adhesive layer is immediately adjacent the first major surface of the first substrate;
printing one or more barrier elements on the first major surface of the adhesive layer;
setting the one or more barrier elements;
laminating a light redirecting layer on the first major surface of the adhesive layer;
   wherein the light redirecting layer comprises one or more microstructured prismatic elements on its first major surface defining a light redirecting area;
   wherein the total surface area of the one or more barrier elements is greater than 60% of the light redirecting area;
   wherein the first major surface of the adhesive layer has a first region and a second region;
   wherein the first region of the first surface of the adhesive layer is in contact with the one or more barrier elements;
   wherein the second region of the first surface of the adhesive layer is in contact with one or more microstructured prismatic elements;
   wherein the article allows transmission of visible light.

In other embodiments, the printing of the one or more barrier elements can be done by direct or offset printing by processes chosen from flexographic printing, gravure printing, screen printing, letterpress printing, lithographic printing, ink-jet printing, digitally controlled spraying, thermal printing, and combinations thereof.

In yet other embodiments, setting the one or more barrier elements occurs by a method chosen from UV radiation curing, e-beam-radiation curing, thermal curing, chemical curing, and cooling.

### Exemplary Embodiments

1. An article comprising:
a light redirecting layer comprising a first major surface and a second major surface;
one or more barrier elements;
an adhesive layer;
wherein the light redirecting layer comprises one or more microstructured prismatic elements on its first major surface defining a light redirecting area;
wherein the total surface area of the one or more barrier elements is greater than 60% of the light redirecting area;
wherein the adhesive layer comprises a first major surface and a second major surface;
wherein the first major surface of the adhesive layer has a first region and a second region;
wherein the first region of the first surface of the adhesive layer is in contact with one or more barrier elements;
wherein the second region of the first surface of the adhesive layer is in contact with one or more microstructured prismatic elements;
wherein the article allows transmission of visible light.
   2. An article according to embodiment 1, wherein the light redirecting layer comprises a light redirecting substrate, and wherein the one or more microstructured prismatic elements are on the light redirecting substrate.
   3. An article according to any of the preceding embodiments, wherein the total surface area of the one or more barrier elements is greater than 65% of the light redirecting area.
   4. An article according to any of the preceding embodiments, wherein the total surface area of the one or more barrier elements is greater than 70% of the light redirecting area.
   5. An article according to any of the preceding embodiments, wherein the total surface area of the one or more barrier elements is greater than 80% of the light redirecting area.
   6. An article according to any of the preceding embodiments, wherein the total surface area of the one or more barrier elements is greater than 90% of the light redirecting area.
   7. An article according to any of the preceding embodiments, wherein the total surface area of the one or more barrier elements is greater than 95% of the light redirecting area.
   8. An article according to any of the preceding embodiments, wherein the total surface area of the one or more barrier elements is greater than 98% of the light redirecting area.
   9. An article according to any of the preceding embodiments, wherein a barrier element diffuses visible light.
   10. An article according to any of the preceding embodiments, wherein a barrier element comprises a diffusing agent.
   11. An article according to any of the preceding embodiments, wherein a barrier element comprises particles as a diffusing agent
   12. An article according to any of the preceding embodiments, wherein the adhesive layer comprises a diffusing agent.
   13. An article according to any of the preceding embodiments, wherein the adhesive layer comprises particles as a diffusing agent.
   14. An article according to any of the preceding embodiments, wherein the window film adhesive layer comprises a diffusing agent.
   15. An article according to any of the preceding embodiments, wherein the window film adhesive layer comprises particles as a diffusing agent.
   16. An article according to any of the preceding embodiments, wherein the surface roughness of a barrier element provides visible-light diffusing properties to the barrier element.
   17. An article according to any of the preceding embodiments, wherein a barrier element comprises one or more light stabilizers.
   18. An article according to any of the preceding embodiments, wherein the material of the barrier elements has been cured using UV radiation or heat.
   19. An article according to any of the preceding embodiments, wherein the barrier elements are laid out in a pattern chosen from a repeating 1-dimensional pattern, a repeating 2-dimensional pattern, and a random-looking 1- or 2-dimensional pattern.
   20. An article according to any of the preceding embodiments, wherein the center-to-center distance between barrier elements defines the pitch; and wherein the average pitch in the article is from 0.035 millimeters to 100 millimeters.
   21. An article according to any of the preceding embodiments, wherein the center-to-center distance between barrier elements defines the pitch; and wherein the average pitch in the article is from 0.1 millimeters to 10 millimeters.
   22. An article according to any of the preceding embodiments, wherein the center-to-center distance between barrier elements defines the pitch; and wherein the average pitch in the article is from 0.5 millimeters to 5 millimeters.
   23. An article according to any of the preceding embodiments, wherein the center-to-center distance between barrier elements defines the pitch; and wherein the average pitch in the article is from 0.75 millimeters to 3 millimeters.
   24. An article according to any of the preceding embodiments, wherein the width of a channel of the second region of the first surface of the adhesive layer defines a gap; and wherein the average gap in the article is from 0.01 millimeters to 40 millimeters.
   25. An article according to any of the preceding embodiments, wherein the adhesive in the adhesive layer is chosen from a pressure sensitive adhesive, a thermoset adhesive, hot melt adhesive, and a UV-curable adhesive.
   26. An article according to any of the preceding embodiments, wherein the adhesive in the adhesive layer is a pressure sensitive adhesive.
   27. An article according to any of the preceding embodiments, wherein the adhesive layer comprises one or more UV stabilizers.
   28. An article according to any of the preceding embodiments, wherein the refractive index of the material of the microstructured prismatic elements matches the refractive index of the adhesive layer.
   29. An article according to any of the preceding embodiments, further comprising a first substrate adjacent the second major surface of the adhesive layer.
   30. An article according to any of the preceding embodiments, wherein the peel strength for the bond between the first substrate and the light redirecting layer is from 25 On to 2,000 g/in.
   31. An article according to any of the preceding embodiments, wherein the peel strength for the bond between the first substrate and the light redirecting layer is greater than 300 g/in.
   32. An article according to any of the preceding embodiments, wherein the peel strength for the bond between the first substrate and the light redirecting layer is greater than 400 g/in.
   33. An article according to any of the preceding embodiments, wherein the peel strength for the bond between the first substrate and the light redirecting layer is greater than 500 g/in.
   34. An article according to any of the preceding embodiments, wherein the second region of the first major surface of the adhesive layer fills the space between at least two immediately adjacent microstructured prismatic elements.
   35. An article according to any of the preceding embodiments, wherein the article has a rectangular or square shape and the edge of all four sides is sealed.
   36. An article according to any of the preceding embodiments, wherein the article has a rectangular or square shape and the edge of at least one side is sealed by the adhesive layer.
   37. An article according to any of the preceding embodiments, wherein the article has a rectangular or square shape and the edge of at least one side is sealed with a sealing agent.
   38. An article according to any of the preceding embodiments, wherein the article has a rectangular or square shape and the edge of at least one side is sealed with an edge sealing tape.
   39. An article according to any of the preceding embodiments, wherein the article has a rectangular or square shape and the edge of at least one side is sealed using pressure, temperature, or a combination of both pressure and temperature.
   40. An article according to any of the preceding embodiments, wherein the article has a circular or ellipsoidal shape and the edge of the article is sealed all around.
   41. An article according to any of the preceding embodiments, wherein the article has a circular or ellipsoidal shape and at least a portion of the edge of the article is sealed by the adhesive layer.
   42. An article according to any of the preceding embodiments, wherein the article has a circular or ellipsoidal shape and at least a portion of the edge of the article is sealed with a sealing agent.
   43. An article according to any of the preceding embodiments, wherein the article has a circular or ellipsoidal shape and at least a portion of the edge of the article is sealed with an edge sealing tape.
   44. An article according to any of the preceding embodiments, wherein the article has a circular or ellipsoidal shape and at least a portion of the edge of the article is sealed using pressure, temperature, or a combination of both pressure and temperature.
   45. A film comprising an article according to any of the preceding embodiments,
wherein the article further comprises a second substrate adjacent the second major surface of the adhesive layer;
wherein the article further comprises a window film adhesive layer adjacent the second major surface of the light redirecting layer; and
wherein the article optionally further comprises a liner adjacent the window film adhesive layer.
   46. A film according to embodiment Error! Reference source not found., further comprising a diffuser adjacent the second substrate.
   47. A film according to embodiment Error! Reference source not found., further wherein the second substrate comprises a diffuser.
   48. A window comprising a film as embodimented as in any of the preceding embodiments directed to a film, wherein the window further comprises a glazing immediately adjacent the window film adhesive layer.
   49. A film comprising an article according to any of the preceding embodiments directed to an article,
wherein the article further comprises a second substrate adjacent the second major surface of the light redirecting layer;
wherein the article optionally further comprises a liner adjacent the adhesive layer.
   50. A film according to embodiment Error! Reference source not found., further comprising a diffuser adjacent the second substrate.
   51. A film according to embodiment Error! Reference source not found., further wherein the second substrate comprises a diffuser.
   52. A window comprising a film as embodimented as in any of embodiments Error! Reference source not found. to Error! Reference source not found., wherein the window further comprises a glazing immediately adjacent the adhesive layer.
   53. A film comprising an article according to any of the preceding embodiments directed to an article, wherein the article further comprises:
a second substrate adjacent the second major surface of the light redirecting layer
a third substrate immediately adjacent the adhesive layer;
a window film adhesive layer immediately adjacent the third substrate; and
optionally a liner adjacent the window film adhesive layer.
   54. A film according to embodiment Error! Reference source not found., further comprising a diffuser adjacent the second substrate.
   55. A film according to embodiment Error! Reference source not found., further wherein the second substrate comprises a diffuser.
   56. A window comprising a film as embodimented as in any of embodiments Error! Reference source not found. to Error! Reference source not found., wherein the window further comprises a glazing immediately adjacent the window film adhesive layer.
   57. A film according to any of the preceding embodiments directed to films that comprise a diffuser, wherein the diffuser is chosen from bulk diffusers, surface diffusers, and embedded diffusers or combinations thereof.
   58. A window according to any of the preceding embodiments directed to windows that comprise a diffuser, wherein the diffuser is chosen from bulk diffusers, surface diffusers, and embedded diffusers or combinations thereof.
   59. A film comprising an article,
wherein the article comprises:
   a light redirecting layer comprising a first major surface and a second major surface;
      wherein the light redirecting layer comprises one or more microstructured prismatic elements on its first major surface defining a light redirecting area;
   one or more barrier elements;
      wherein the total surface area of the one or more barrier elements is greater than 90% of the light redirecting area;
   an adhesive layer;
      wherein the adhesive layer comprises a first major surface and a second major surface;
      wherein the first major surface of the adhesive layer has a first region and a second region;
      wherein the first region of the first surface of the adhesive layer is in contact with one or more barrier elements;
      wherein the second region of the first surface of the adhesive layer is in contact with one or more microstructured prismatic elements;
   a first substrate adjacent the second major surface of the adhesive layer;
      wherein the first substrate comprises a diffuser; and
   a window film adhesive layer adjacent the second surface of the light redirecting layer;
   wherein the article allows transmission of visible light;
wherein the film optionally further comprises a liner immediately adjacent the window film adhesive layer.
   60. A film comprising an article,
wherein the article comprises:
   a light redirecting layer comprising a first major surface and a second major surface;
      wherein the light redirecting layer comprises one or more microstructured prismatic elements on its first major surface defining a light redirecting area;
   one or more barrier elements;
      wherein the total surface area of the one or more barrier elements is greater than 90% of the light redirecting area;
   an adhesive layer;
      wherein the adhesive layer comprises a first major surface and a second major surface;
      wherein the first major surface of the adhesive layer has a first region and a second region;
      wherein the first region of the first surface of the adhesive layer is in contact with one or more barrier elements;
      wherein the second region of the first surface of the adhesive layer is in contact with one or more microstructured prismatic elements;
   a diffuser adjacent the second major surface of the light redirecting layer;
   a first substrate immediately adjacent the adhesive layer;
   a window film adhesive layer immediately adjacent the first substrate;
   wherein the article allows transmission of visible light;
wherein the film optionally further comprises a liner immediately adjacent the window film adhesive layer.
   61. A film comprising an article,
wherein the article comprises:
   a light redirecting layer comprising a first major surface and a second major surface;
      wherein the light redirecting layer comprises one or more microstructured prismatic elements on its first major surface defining a light redirecting area;
   one or more barrier elements;
      wherein the total surface area of the one or more barrier elements is greater than 90% of the light redirecting area;
   an adhesive layer;
      wherein the adhesive layer comprises a first major surface and a second major surface;
      wherein the first major surface of the adhesive layer has a first region and a second region;
      wherein the first region of the first surface of the adhesive layer is in contact with one or more barrier elements;
      wherein the second region of the first surface of the adhesive layer is in contact with one or more microstructured prismatic elements;
   a diffuser adjacent the second major surface of the light redirecting layer;
   wherein the article allows transmission of visible light;
wherein the film optionally further comprises a liner immediately adjacent the adhesive layer.
   62. An article comprising:
a light redirecting layer comprising a first major surface and a second major surface;
one or more barrier elements;
an adhesive layer;
wherein the light redirecting layer comprises one or more microstructured prismatic elements on its first major surface defining a light redirecting area;
wherein the total surface area of the one or more barrier elements in at least a portion of the article defined as a light redirecting region is greater than 60% of the light redirecting area;
wherein the adhesive layer comprises a first major surface and a second major surface;
wherein the first major surface of the adhesive layer has a first region and a second region;
wherein the first region of the first surface of the adhesive layer is in contact with one or more barrier elements;
wherein the second region of the first surface of the adhesive layer is in contact with one or more microstructured prismatic elements;
wherein the article allows transmission of visible light.
   63. An article according to embodiment Error! Reference source not found., wherein portions of the light redirecting area that are not part of the light redirecting region are clear enough to allow a user to see through the construction.
   64. A method of making an article comprising:
providing a first substrate having a first major surface and a second major surface opposite the first major surface;
applying an adhesive layer to the first major surface of the first substrate;
   wherein the adhesive layer has a first major surface and a second major surface opposite the first major surface; and wherein the second major surface of the adhesive layer is immediately adjacent the first major surface of the first substrate;
printing one or more barrier elements on the first major surface of the adhesive layer;
setting the one or more barrier elements;
laminating a light redirecting layer on the first major surface of the adhesive layer;
wherein the light redirecting layer comprises one or more microstructured prismatic elements on its first major surface defining a light redirecting area;
wherein the total surface area of the one or more barrier elements is greater than 60% of the light redirecting area;
wherein the first major surface of the adhesive layer has a first region and a second region;
wherein the first region of the first surface of the adhesive layer is in contact with the one or more barrier elements;
wherein the second region of the first surface of the adhesive layer is in contact with one or more microstructured prismatic elements;
wherein the article allows transmission of visible light.
   65. A method according to embodiment 0, wherein printing of the one or more barrier elements occurs by direct or offset printing and by process chosen from flexographic printing, gravure printing, screen printing, letterpress printing, lithographic printing, ink-jet printing, digitally controlled spraying, thermal printing, and combinations thereof.
   66. A method according to any of the preceding embodiments directed to methods, wherein setting the one or more barrier elements occurs by a method chosen from UV-radiation curing, e-beam-radiation curing, thermal curing, chemical curing, and cooling.
   67. A method according to any of the preceding embodiments directed to methods, wherein the first substrate comprises a diffuser chosen from bulk diffusers, surface diffusers, and embedded diffusers or combinations thereof.
   68. A method according to any of the preceding embodiments directed to methods, wherein the light redirecting layer comprises a light redirecting substrate, and wherein the one or more microstructured prismatic elements are on the light redirecting substrate.
   69. A method according to any of the preceding embodiments directed to methods, wherein the total surface area of the one or more barrier elements is greater than 65% of the light redirecting area.
   70. A method according to any of the preceding embodiments directed to methods, wherein the total surface area of the one or more barrier elements is greater than 70% of the light redirecting area.
   71. A method according to any of the preceding embodiments directed to methods, wherein the total surface area of the one or more barrier elements is greater than 80% of the light redirecting area.
   72. A method according to any of the preceding embodiments directed to methods, wherein the total surface area of the one or more barrier elements is greater than 90% of the light redirecting area.
   73. A method according to any of the preceding embodiments directed to methods, wherein the total surface area of the one or more barrier elements is greater than 95% of the light redirecting area.
   74. A method according to any of the preceding embodiments directed to methods, wherein the total surface area of the one or more barrier elements is greater than 98% of the light redirecting area.
   75. A method according to any of the preceding embodiments directed to methods, wherein a barrier element diffuses visible light.
   76. A method according to any of the preceding embodiments directed to methods, wherein a barrier element comprises a diffusing agent.
   77. A method according to any of the preceding embodiments directed to methods, wherein a barrier element comprises particles as a diffusing agent
   78. A method according to any of the preceding embodiments directed to methods, wherein the adhesive layer comprises a diffusing agent.
   79. A method according to any of the preceding embodiments directed to methods, wherein the adhesive layer comprises particles as a diffusing agent.
   80. A method according to any of the preceding embodiments directed to methods, wherein the window film adhesive layer comprises a diffusing agent.
   81. A method according to any of the preceding embodiments directed to methods, wherein the window film adhesive layer comprises particles as a diffusing agent.
   82. A method according to any of the preceding embodiments directed to methods, wherein the surface roughness of a barrier element provides visible-light diffusing properties to the barrier element.
   83. A method according to any of the preceding embodiments directed to methods, wherein a barrier element comprises one or more light stabilizers.
   84. A method according to any of the preceding embodiments directed to methods, wherein the material of the barrier elements has been cured using UV radiation or heat.
   85. A method according to any of the preceding embodiments directed to methods, wherein the barrier elements are laid out in a pattern chosen from a repeating 1-dimensional pattern, a repeating 2-dimensional pattern, and a random-looking 1- or 2-dimensional pattern.
   86. A method according to any of the preceding embodiments directed to methods, wherein the center-to-center distance between barrier elements defines the pitch; and wherein the average pitch in the article is between 0.035 millimeters and 100 millimeters.
   87. A method according to any of the preceding embodiments directed to methods, wherein the center-to-center distance between barrier elements defines the pitch; and wherein the average pitch in the article is between 0.1 millimeters and 10 millimeters.
   88. A method according to any of the preceding embodiments directed to methods, wherein the center-to-center distance between barrier elements defines the pitch; and wherein the average pitch in the article is between 0.5 millimeters and 5 millimeters.
   89. A method according to any of the preceding embodiments directed to methods, wherein the center-to-center distance between barrier elements defines the pitch; and wherein the average pitch in the article is between 0.75 millimeters and 3 millimeters.
   90. A method according to any of the preceding embodiments directed to methods, wherein the width of a channel of the second region of the first surface of the adhesive layer defines a gap; and wherein the average gap in the article is between 0.01 millimeters and 40 millimeters.
   91. A method according to any of the preceding embodiments directed to methods, wherein the adhesive in the adhesive layer is chosen from a pressure sensitive adhesive, a thermoset adhesive, hot melt adhesive, and a UV-curable adhesive.
   92. A method according to any of the preceding embodiments directed to methods, wherein the adhesive in the adhesive layer is a pressure sensitive adhesive.
   93. A method according to any of the preceding embodiments directed to methods, wherein the adhesive layer comprises one or more UV stabilizers.
   94. A method according to any of the preceding embodiments directed to methods, wherein the refractive index of the material of the microstructured prismatic elements matches the refractive index of the adhesive layer.
   95. A method according to any of the preceding embodiments directed to methods, further comprising a first substrate adjacent the second major surface of the adhesive layer.
   96. A method according to any of the preceding embodiments directed to methods, wherein the peel strength for the bond between the first substrate and the light redirecting layer is from 25 g/in to 2,000 g/in.
   97. A method according to any of the preceding embodiments directed to methods, wherein the peel strength for the bond between the first substrate and the light redirecting layer is greater than 300 g/in.
   98. A method according to any of the preceding embodiments directed to methods, wherein the peel strength for the bond between the first substrate and the light redirecting layer is greater than 400 g/in.
   99. A method according to any of the preceding embodiments directed to methods, wherein the peel strength for the bond between the first substrate and the light redirecting layer is greater than 500 g/in.
   100. A method according to any of the preceding embodiments directed to methods, wherein the second region of the first major surface of the adhesive layer fills the space between at least two immediately adjacent microstructured prismatic elements.
   101. A method according to any of the preceding embodiments directed to methods, wherein the article has a rectangular or square shape and the edge of all four sides is sealed.
   102. A method according to any of the preceding embodiments directed to methods, wherein the article has a rectangular or square shape and the edge of at least one side is sealed by the adhesive layer.
   103. A method according to any of the preceding embodiments directed to methods, wherein the article has a rectangular or square shape and the edge of at least one side is sealed with a sealing agent.
   104. A method according to any of the preceding embodiments directed to methods, wherein the article has a rectangular or square shape and the edge of at least one side is sealed with an edge sealing tape.
   105. A method according to any of the preceding embodiments directed to methods, wherein the article has a rectangular or square shape and the edge of at least one side is thermally sealed.
   106. A method according to any of the preceding embodiments directed to methods, wherein the article has a circular or ellipsoidal shape and the edge of the article is sealed all around.
   107. A method according to any of the preceding embodiments directed to methods, wherein the article has a circular or ellipsoidal shape and at least a portion of the edge of the article is sealed by the adhesive layer.
   108. A method according to any of the preceding embodiments directed to methods, wherein the article has a circular or ellipsoidal shape and at least a portion of the edge of the article is sealed with a sealing agent.
   109. A method according to any of the preceding embodiments directed to methods, wherein the article has a circular or ellipsoidal shape and at least a portion of the edge of the article is sealed with an edge sealing tape.
   110. A method according to any of the preceding embodiments directed to methods, wherein the article has a circular or ellipsoidal shape and at least a portion of the edge of the article is thermally sealed.

### Examples

Adhesive Transfer Tape Suitable for Use with Barrier Elements

Adhesive transfer tape was made by solution coating RD 2738 pressure sensitive adhesive (available from 3M Company, St. Paul, Minn.) between two silicone release liners. After solvent removal, the adhesive layer thickness was 3 mil.

Barrier Element Formulation

The printed barrier elements were made from an acrylate formulation containing 50 wt % Ebecryl 8301-R (Allnex, Smyrna, Ga.), 25 wt % 1,6-hexanediol diacrylate (Ciba/BASF, Hawthorne, NY), and 25 wt % pentaerythritol tetraacrylate (Sigma-Aldrich, St. Louis, Mo.). One weight percent PL-100 photoinitiator was added based on the total weight of the monomers. PL-100 is a 70:30 blend of oligo [2-hydroxy-2-methyl-1-[4-(1-methylvinyl)phenyl]propanone] and 2-hydroxy-2-methyl-1-phenyl-1-propanone that is commercially available from Esstech, Inc., Essington, Pa. These components were combined to provide a uniform mixture.

Barrier Elements Printed on Adhesive Transfer Tape

A flexographic printing plate comprising a predetermined print pattern based on preselected images was used. The print pattern was a random-looking pattern having pitch 1169 microns, gap 135 microns, and designed coverage 78%. Pitch refers to the center-to-center distance between barrier elements, gap refers to the distance between adjacent barrier elements, and designed coverage refers to the percentage of the total area covered by the barrier elements. The flexographic printing plate measured approximately 30.5×30.5 cm and was manually wiped with isopropanol before printing.

The barrier element formulation was then printed onto the adhesive using a flexographic printing process. The flexographic printing plate was mounted on a smooth roll of a flexographic printing apparatus using 1060 Cushion-Mount flexographic plate mounting tape (3M Company, St. Paul, Minn.). The barrier element formulation was introduced into the flexographic printing apparatus using conventional methods and equipment and was transferred onto the printing surfaces of the flexographic printing plate via an anilox roll. The printable composition was then transferred to the adhesive film at a line speed of approximately 3 meters per minute. The coated adhesive film then passed through a Maxwell UV curing apparatus (available from XericWeb, Neenah, Wis.) that was in-line with the printing apparatus. The UV curing apparatus was operated at full power with nitrogen gas inerting. The printed barrier element construction is shown in FIG. 15, and has been stained to enhance the contrast between the barrier elements and the gaps.

### Laminate Comprising Printed Adhesive Transfer Tape and a Daylight Redirecting Film

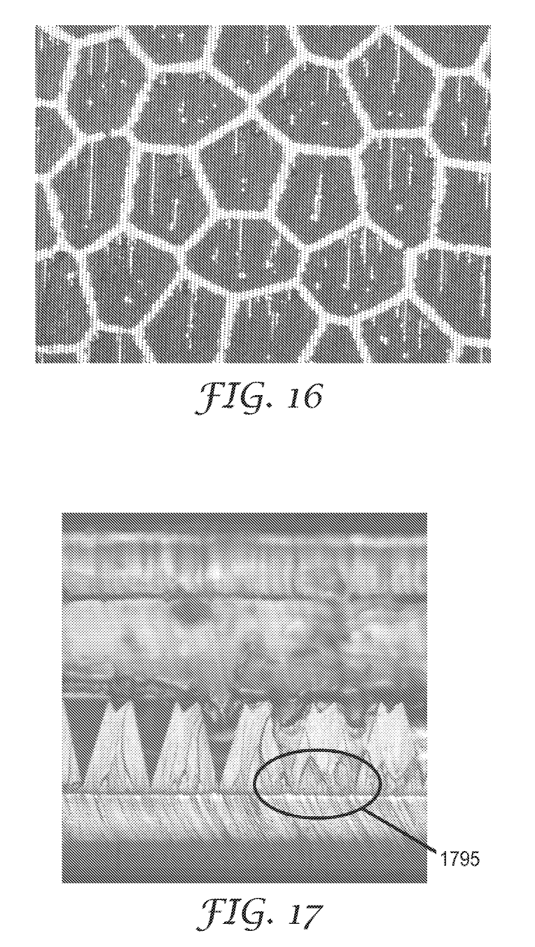

The adhesive transfer tape printed with barrier elements was then laminated to a 3M daylight redirecting microstructured film under heat (190° F.) and pressure (40 psi) at a line speed of 15 feet per minute. FIG. 16 is an image of the laminate in transmission. The fine vertical lines in FIG. 16 are the linear light redirecting microstructures. The darker regions are the barrier elements where the microstructures are active (i.e., able to redirect light). The lighter regions are regions where the adhesive has filled the microstructures and rendered them partially optically active, permitting transmission of light without full redirection, which is sometimes referred to as “punch through”. FIG. 17 is a cross section of the laminate, showing that adhesive can flow to the bottom of the microstructure, as can be seen in region 1795.

Under these lamination conditions the adhesive flows all the way down to the bottom of the valleys between the microstructures, as indicated at 1795 in FIG. 17. This flow of adhesive to the bottom of the valleys of the microstructures combined with the two dimensional interconnected adhesive pattern fully seals the laminate from contaminants such as water.

Immersion Testing and Optical Performance

A demonstration that the interconnected adhesive pattern fully sealed the laminate was shown by immersing and removing the above assembly in water without loss of optical performance.

The optical performance of this laminate was characterized using an IS-SA-13-1 Imaging Sphere from Radiant-Zemax (Redmond, Wash.). The sample was illuminated at 37 degree elevation using a metal halide light source and the angular profile of the transmitted light was measured.

FIG. 10a is a conoscopic plot of a construction having barrier elements with a designed coverage of about 78%. Light redirected upwards can be seen in the upper quadrants. The “punch through” 1070 going downwards is circled in the lower quadrants. Punch through represents light that traverses the optical construction largely undeviated. Punch through may result in glare depending on the solar elevation.

The light redirection performance can be quantified by the UpRatio which defined as:

$$UpRatio = \frac{Up}{Up + Down} ;$$

In this UpRatio, Up refers to the fraction of light that is redirected upward and Down refers to the fraction of the light that is redirected downward. For this sample and at this elevation angle the UpRatio is approximately 73%.

1. An article comprising:
a light redirecting layer comprising a first major surface and a second major surface;
one or more barrier elements;
an adhesive layer;
wherein the light redirecting layer comprises one or more microstructured prismatic elements at its first major surface defining a light redirecting area;
wherein the total surface area of the one or more barrier elements is greater than 60% of the light redirecting area;
wherein the adhesive layer comprises a first major surface and a second major surface;
wherein the first major surface of the adhesive layer has a first region and a second region;
wherein the first region of the first surface of the adhesive layer is in contact with one or more barrier elements;
wherein the second region of the first surface of the adhesive layer is in contact with one or more microstructured prismatic elements;
wherein the article allows transmission of visible light.

2. An article according to claim 1, wherein the light redirecting layer comprises a light redirecting substrate, and wherein the one or more microstructured prismatic elements are on the light redirecting substrate.

3. An article according to claim 1, wherein the total surface area of the one or more barrier elements is greater than 70% of the light redirecting area.

4. An article according to claim 1, wherein a barrier element diffuses visible light.

5. An article according to claim 1, wherein the adhesive layer comprises a diffusing agent.

6. An article according to claim 1, wherein the window film adhesive layer comprises a diffusing agent.

7. An article according to claim 1, wherein the surface roughness of a barrier element provides visible-light diffusing properties to the barrier element.

8. An article according to claim 1, wherein the barrier elements are laid out in a pattern chosen from a repeating 1-dimensional pattern, a repeating 2-dimensional pattern, and a random-looking 1- or 2-dimensional pattern.

9. An article according to claim 1, wherein the center-to-center distance between barrier elements defines the pitch; and wherein the average pitch in the article is from 0.035 millimeters to 100 millimeters.

10. An article according to claim 1, wherein the adhesive in the adhesive layer is chosen from a pressure sensitive adhesive, a thermoset adhesive, hot melt adhesive, and a UV-curable adhesive.

11. An article according to claim 1, wherein the refractive index of the material of the microstructured prismatic elements matches the refractive index of the adhesive layer.

12. An article according to claim 1, wherein the peel strength for the bond between the first substrate and the light redirecting layer is greater than 300 g/in.

13. An article according to claim 1, wherein the article has a rectangular or square shape and the edge of all four sides is sealed.

14. A film comprising an article,
wherein the article comprises:
a light redirecting layer comprising a first major surface and a second major surface;
wherein the light redirecting layer comprises one or more microstructured prismatic elements on its first major surface defining a light redirecting area;
one or more barrier elements;
wherein the total surface area of the one or more barrier elements is greater than 90% of the light redirecting area;
an adhesive layer;
wherein the adhesive layer comprises a first major surface and a second major surface;
wherein the first major surface of the adhesive layer has a first region and a second region;
wherein the first region of the first surface of the adhesive layer is in contact with one or more barrier elements;
wherein the second region of the first surface of the adhesive layer is in contact with one or more microstructured prismatic elements;
a first substrate adjacent the second major surface of the adhesive layer;
wherein the first substrate comprises a diffuser; and
a window film adhesive layer adjacent the second surface of the light redirecting layer;
wherein the article allows transmission of visible light;
wherein the film optionally further comprises a liner immediately adjacent the window film adhesive layer.

15. A method of making an article comprising:
providing a first substrate having a first major surface and a second major surface opposite the first major surface;
applying an adhesive layer to the first major surface of the first substrate;
wherein the adhesive layer has a first major surface and a second major surface opposite the first major surface; and wherein the second major surface of the adhesive layer is immediately adjacent the first major surface of the first substrate;
printing one or more barrier elements on the first major surface of the adhesive layer;
setting the one or more barrier elements;
laminating a light redirecting layer on the first major surface of the adhesive layer;
wherein the light redirecting layer comprises one or more microstructured prismatic elements on its first major surface defining a light redirecting area;
wherein the total surface area of the one or more barrier elements is greater than 60% of the light redirecting area;
wherein the first major surface of the adhesive layer has a first region and a second region;
wherein the first region of the first surface of the adhesive layer is in contact with the one or more barrier elements;
wherein the second region of the first surface of the adhesive layer is in contact with one or more microstructured prismatic elements;
wherein the article allows transmission of visible light.
